(19) United States
(12) Patent Application Publication
(10) Pub. No.: US 2026/0046916 A1
(43) Pub. Date: Feb. 12, 2026

(54) COMMUNICATION DEVICE AND VEHICLE CONTROL DEVICE INCLUDING THE SAME

(71) Applicant: LG ELECTRONICS INC., Seoul (KR)

(72) Inventors: Jinseob KIM, Seoul (KR); Jaeyoung AHN, Seoul (KR); Seungyeol SEO, Seoul (KR); Kabjoo KIM, Seoul (KR)

(73) Assignee: LG ELECTRONICS INC., Seoul (KR)

(21) Appl. No.: 19/292,771

(22) Filed: Aug. 6, 2025

(30) Foreign Application Priority Data
Aug. 8, 2024 (WO) PCT/KR2024/011773

(51) Int. Cl. H04W 72/56; H04B 17/20; H04W 4/46

(52) U.S. Cl. CPC H04W 72/56; H04B 17/203; H04W 4/46

(57) ABSTRACT

A communication device and a vehicle control device including the same according to an embodiment of the present disclosure include: an RF communication device configured to receive vehicle messages from a plurality of adjacent external vehicles based on an RF signal; and a processor configured to perform filtering of the vehicle messages based on road type information, receiver sensitivity information of the RF signal, wheel direction information, and speed information. Accordingly, the vehicle messages received from the adjacent vehicles may be efficiently filtered.

### CROSS-REFERENCE TO RELATED APPLICATION(S)

Pursuant to 35 U.S.C. § 119, this application claims the benefit of earlier filing date and right of priority to International Application No. PCT/KR2024/011773, filed on Aug. 8, 2024, the contents of which are all incorporated by reference herein in their entirety.

### BACKGROUND

### 1. Technical Field

The present disclosure relates to a communication device and a vehicle control device including the same, and more particularly to a communication device capable of efficiently filtering vehicle messages received from adjacent vehicles, and a vehicle control device including the communication device.

### 2. Description of the Related Art

A vehicle is a machine that allows a user to move in a desired direction. A typical example of the vehicle is an automobile.

Meanwhile, a vehicle communication device is provided for a vehicle as data used therein increases.

For example, the vehicle communication device receives data from an external server or adjacent vehicles based on mobile communication technology.

Particularly, the vehicle receives various vehicle messages in the Vehicle-to-everything (V2X) environment.

Meanwhile, as the number of received vehicle messages increases, processing required to be performed in the vehicle increases.

U.S. Pat. No. 11,511,767 as related art discloses processing only V2X data messages related to vehicles, based on filtering technology.

However, the related art has a drawback in that filtering is not performed based on driving situations, particularly, the road type, and thus efficient filtering may not be provided.

### SUMMARY

It is an objective of the present disclosure to provide a communication device capable of efficiently filtering vehicle messages received from adjacent vehicles, and a vehicle control device including the communication device.

Meanwhile, it is another objective of the present disclosure to provide a communication device capable of efficiently filtering vehicle messages received from adjacent vehicles based on road type information, and a vehicle control device including the communication device.

Meanwhile, it is yet another objective of the present disclosure to provide a communication device capable of efficiently filtering vehicle messages received from adjacent vehicles based on road type information and a utilization of a processor, and a vehicle control device including the communication device.

Meanwhile, it is further another objective of the present disclosure to provide a communication device capable of efficiently filtering vehicle messages based on an application executed in a signal processing device, and a vehicle control device including the communication device.

In accordance with an aspect of the present disclosure, the above and other objectives can be accomplished by providing a communication device and a vehicle control device including the same, which include: an RF communication device configured to receive vehicle messages from a plurality of adjacent external vehicles based on an RF signal; and a processor configured to perform filtering of the vehicle messages based on road type information, receiver sensitivity information of the RF signal, wheel direction information, and speed information.

Meanwhile, the processor may be configured to set a message passing zone based on the road type information, receiver sensitivity information of the RF signal, wheel direction information, and speed information, and to perform filtering of the vehicle messages based on the message passing zone.

Meanwhile, the processor may be configured to pass vehicle messages from external vehicles included in the message passing zone, and to block vehicle messages from external vehicles not included in the message passing zone.

Meanwhile, the processor may be configured to set priority levels based on the road type information, receiver sensitivity information of the RF signal, wheel direction information, and speed information, and to perform filtering of the vehicle messages based on the priority levels.

Meanwhile, in response to the road type being a straight road or a curved road, the processor may be configured to set a priority level of the speed information to a highest level and a priority level of the wheel direction information to a lowest level; and in response to the road type being an intersection, the processor may be configured to set a priority level of the wheel direction information to a highest level and a priority level of the speed information to a lowest level.

Meanwhile, the processor may be configured to set a message passing zone based on the set priority levels, and to perform filtering of the vehicle messages based on the message passing zone.

Meanwhile, in response to the road type being a straight road or a curved road, the processor may be configured to increase the message passing zone as a level of the speed information increases.

Meanwhile, in response to the road type being an intersection, the processor may be configured to set a direction or location of the message passing zone based on the wheel direction information.

Meanwhile, the processor may be configured to set the priority levels based further on a turn signal, traffic congestion area information, and speed variation information.

Meanwhile, the processor may be configured to decrease the message passing zone as a congestion level based on the traffic congestion information increases or a speed variation of the speed variation information decreases.

Meanwhile, in response to a utilization of the processor being greater than or equal to a reference value, the processor may be configured to perform filtering of the vehicle messages.

Meanwhile, the processor may be configured to block a first number of vehicle messages in response to a utilization of the processor being a first level, and to block a second number of vehicle messages in response to a utilization of the processor being a second level greater than the first level, the second number being greater than the first number.

Meanwhile, the processor may be configured to decrease the message passing zone as the utilization of the processor increases.

Meanwhile, the RF communication device may be configured to transmit transmission interval information of the vehicle messages to the external vehicles based on the message passing zone.

Meanwhile, the RF communication device may be configured to control a transmission interval of the vehicle messages of the external vehicles to become longer as a size of the message passing zone decreases.

Meanwhile, the communication device may further include an interface configured to exchange data with a signal processing device, wherein the processor may be configured to set the message passing zone based on an application executed in the signal processing device.

Meanwhile, the processor may be configured to change the message passing zone based on an application executed in the signal processing device and a traveling direction of the vehicle.

Meanwhile, in response to an autonomous emergency steering (AES) control application being executed in the signal processing device, the processor may be configured to change the message passing zone based on a traveling direction of the vehicle.

Meanwhile, in response to an autonomous emergency braking (AEB) control application being executed in the signal processing device, the processor may be configured to change the message passing zone to a rear area of the vehicle.

In accordance with another aspect of the present disclosure, the above and other objectives can be accomplished by providing a communication device and a vehicle control device including the same, which include: an RF communication device configured to receive vehicle messages from a plurality of adjacent external vehicles based on an RF signal; and a processor configured to perform filtering of the vehicle messages, wherein the processor is configured to perform filtering of the vehicle messages based on road type information and a utilization of the processor.

### BRIEF DESCRIPTION OF THE DRAWINGS

The embodiments will be described in detail with reference to the following drawings in which like reference numerals refer to like elements wherein:

FIG. 1 is a diagram illustrating an example of the exterior and interior of a vehicle;

FIG. 2 is a diagram illustrating an example of the architecture of a vehicle signal processing system;

FIG. 3A is a diagram illustrating an example of a vehicle display apparatus in a vehicle;

FIG. 3B is a diagram illustrating another example of a vehicle display apparatus in a vehicle;

FIG. 4 is an exemplary internal block diagram of the vehicle of FIG. 1;

FIG. 5 is an exemplary block diagram of a vehicle control device according to an embodiment of the present disclosure;

FIG. 6 is an exemplary block diagram of a communication device according to an embodiment of the present disclosure;

FIG. 7A is a flowchart illustrating a method of operating a communication device according to an embodiment of the present disclosure;

FIG. 7B is a flowchart illustrating a method of operating a communication device according to another embodiment of the present disclosure; and

FIGS. 8A to 19D are diagrams referred to in the description of operation of FIGS. 7A and 7B.

### DETAILED DESCRIPTION

Hereinafter, the present disclosure will be described in detail with reference to the accompanying drawings.

With respect to constituent elements used in the following description, suffixes “module” and “unit” are given only in consideration of ease in preparation of the specification, and do not have or serve different meanings. Accordingly, the suffixes “module” and “unit” may be used interchangeably.

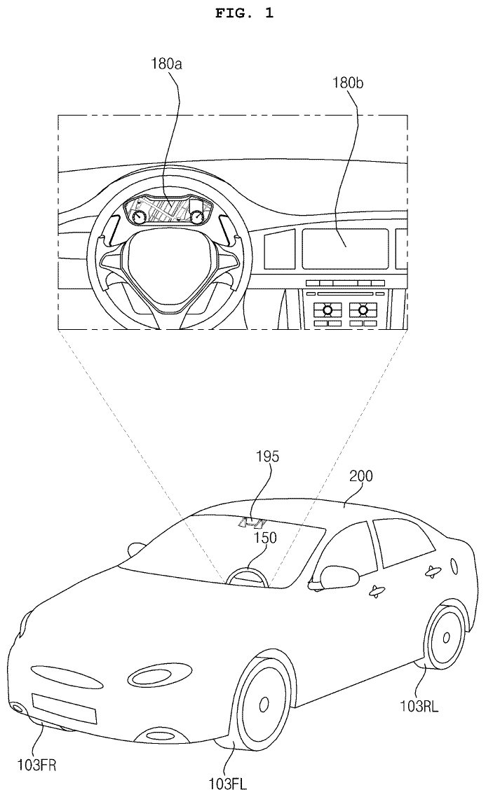

FIG. 1 is a diagram illustrating an example of the exterior and interior of a vehicle.

Referring to the figure, the vehicle 200 is moved by a plurality of wheels 103FR, 103FL, 103RL, . . . rotated by a power source and a steering wheel 150 configured to adjust an advancing direction of the vehicle 200.

Meanwhile, the vehicle 200 may be provided with a camera 195 configured to acquire an image of the front of the vehicle.

Meanwhile, the vehicle 200 may be further provided therein with a plurality of displays 180a and 180b configured to display images and information.

In FIG. 1, a cluster display 180a and an audio video navigation (AVN) display 180b are illustrated as the plurality of displays 180a and 180b. In addition, a head up display (HUD) may also be used.

Meanwhile, the audio video navigation (AVN) display 180b may also be called a center information display.

Meanwhile, the vehicle 200 described in this specification may be a concept including all of a vehicle having an engine as a power source, a hybrid vehicle having an engine and an electric motor as a power source, and an electric vehicle having an electric motor as a power source.

FIG. 2 is a diagram illustrating an example of the architecture of a vehicle signal processing system.

Referring to the figure, an architecture 300a of a vehicle signal processing system may correspond to a zone-based architecture.

Accordingly, vehicle internal sensor devices and processors may be mounted in each of a plurality of zones Z1 to Z4, and a signal processing device 170a including a vehicle communication gateway GWDa may be disposed at the center of the plurality of zones Z1 to Z4.

Meanwhile, the signal processing device 170a may further include an autonomous driving control module ACC, a cockpit control module CPG, etc., in addition to the vehicle communication gateway GWDa.

The vehicle communication gateway GWDa in the signal processing device 170a may be a High Performance Computing (HPC) gateway.

That is, as an integrated HPC gateway, the signal processing device 170a of FIG. 2 may exchange data with an external communication device (not shown) or processors (not shown) in the plurality of zones Z1 to Z4.

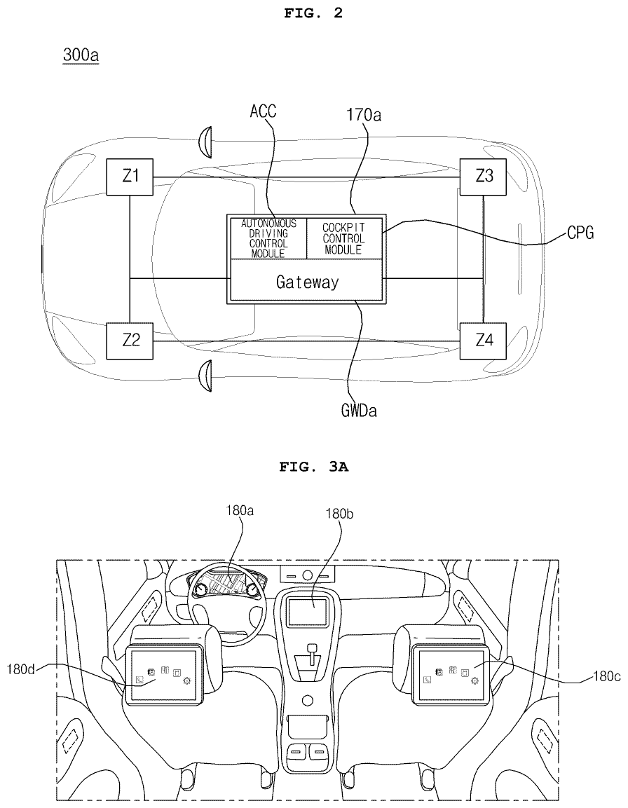

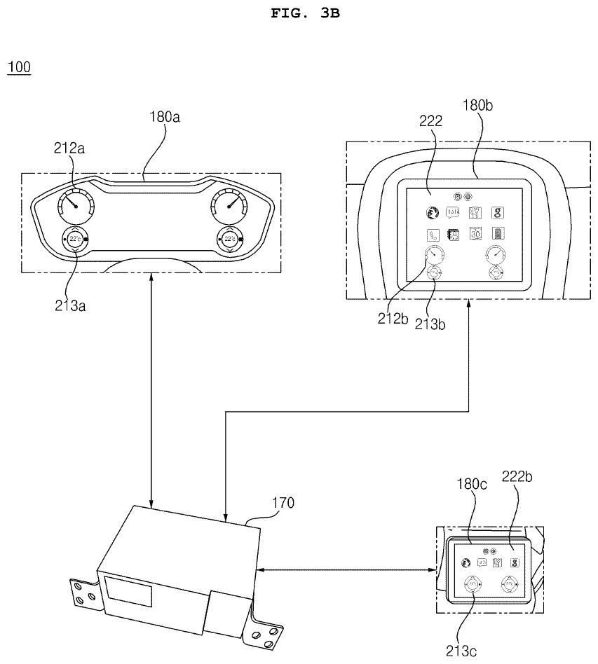

FIG. 3A is a diagram illustrating an example of a vehicle display apparatus in a vehicle.

Referring to the figure, a cluster display 180a, an audio video navigation (AVN) display 180b, rear seat entertainment displays 180c and 180d, and a rear-view mirror display (not shown) may be mounted in the vehicle.

FIG. 3B is a diagram illustrating another example of a vehicle display apparatus in a vehicle.

A vehicle display apparatus 100 according to the embodiment of the present disclosure may include a plurality of displays 180a and 180b and a signal processing device 170 configured to perform signal processing in order to display images and information on the plurality of displays 180a and 180b, and to output an image signal to at least one of the displays 180a and 180b.

The first display 180a, which is one of the plurality of displays 180a and 180b, may be a cluster display 180a configured to display a driving state and operation information, and the second display 180b may be an audio video navigation (AVN) display 180b configured to display vehicle driving information, a navigation map, various kinds of entertainment information, or an image.

The signal processing device 170 may have a processor 175 provided therein, and first to third virtual machines (not shown) may be executed by a hypervisor 505 in the processor 175.

The second virtual machine (not shown) may be operated for the first display 180a, and the third virtual machine (not shown) may be operated for the second display 180b.

Meanwhile, the first virtual machine (not shown) in the processor 175 may be configured to set a shared memory 508 based on the hypervisor 505 for transmission of the same data to the second virtual machine (not shown) and the third virtual machine (not shown). Consequently, the first display 180a and the second display 180b in the vehicle may display the same information or the same images in a synchronized state.

Meanwhile, the first virtual machine (not shown) in the processor 175 shares at least some of data with the second virtual machine (not shown) and the third virtual machine (not shown) for divided processing of data. Consequently, the plurality of virtual machines for the plurality of displays in the vehicle may divide and process data.

Meanwhile, the first virtual machine (not shown) in the processor 175 may receive and process wheel speed sensor data of the vehicle, and may transmit the processed wheel speed sensor data to at least one of the second virtual machine (not shown) or the third virtual machine (not shown). Consequently, at least one virtual machine may share the wheel speed sensor data of the vehicle.

Meanwhile, the vehicle display apparatus 100 according to the embodiment of the present disclosure may further include a rear seat entertainment (RSE) display 180c configured to display driving state information, simple navigation information, various kinds of entertainment information, or an image.

The signal processing device 170 may further execute a fourth virtual machine (not shown), in addition to the first to third virtual machines (not shown), on the hypervisor 505 in the processor 175 to control the RSE display 180c.

Consequently, it is possible to control various displays 180a to 180c using a single signal processing device 170.

Meanwhile, some of the plurality of displays 180a to 180c may be operated based on a Linux Operating System (OS), and others may be operated based on a Web Operating System (OS).

The signal processing device 170 according to the embodiment of the present disclosure may be configured to display the same information or the same images in a synchronized state on the displays 180a to 180c to be operated under various operating systems.

Meanwhile, FIG. 3B illustrates an example in which a vehicle speed indicator 212a and a vehicle internal temperature indicator 213a are displayed on a first display 180a, a home screen 222 including a plurality of applications, a vehicle speed indicator 212b, and a vehicle internal temperature indicator 213b is displayed on a second display 180b, and a second home screen 222b including a plurality of applications and a vehicle internal temperature indicator 213c is displayed on a third display 180c.

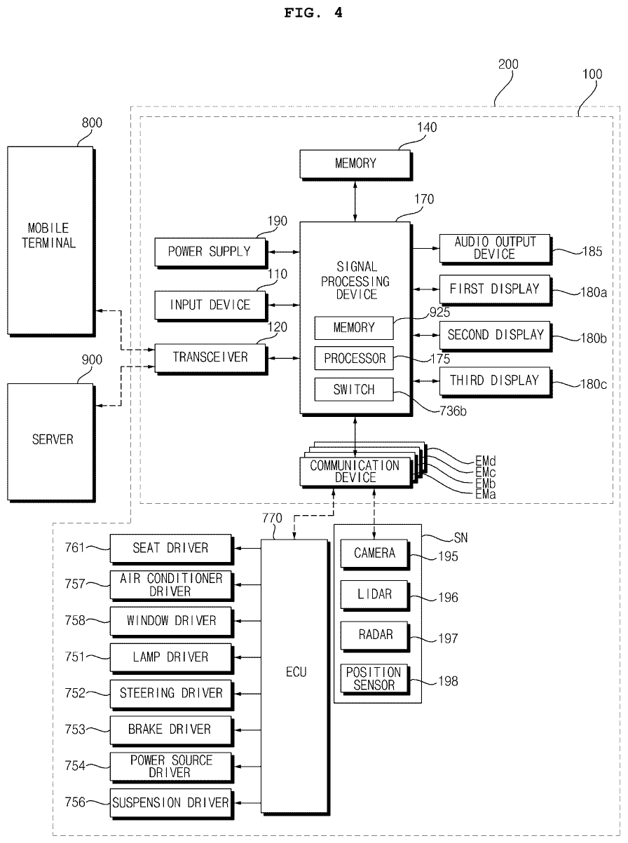

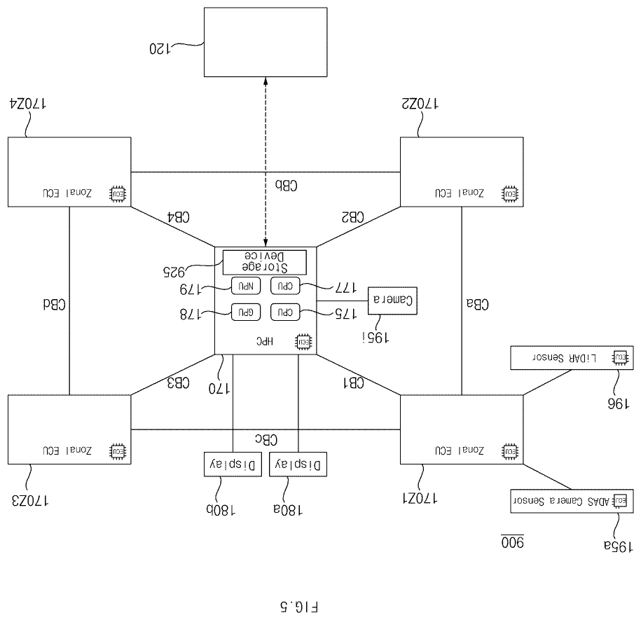

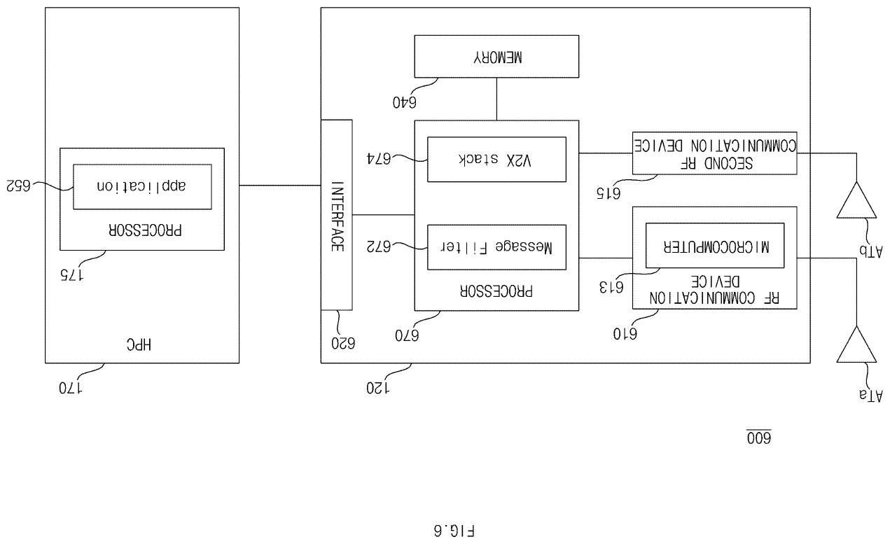

FIG. 4 is an exemplary internal block diagram of the vehicle of FIG. 1.

Referring to the figure, the vehicle 200 according to an embodiment of the present disclosure may include a lamp driver 751, a steering driver 752, a brake driver 753, a power source driver 754, a suspension driver 756, an air conditioner driver 755, a window driver 758, a seat driver 761, and the signal processing device 170.

Meanwhile, the vehicle 200 may further include an ECU 770, a plurality of sensor devices SN, and a plurality of communication devices EMa to EMd.

Meanwhile, the vehicle 200 according to an embodiment of the present disclosure may further include the vehicle display apparatus 100.

Referring to the figure, the vehicle display apparatus 100 according to the embodiment of the present disclosure may include an input device 110, a transceiver 120 for communication with an external device, the plurality of communication devices EMa to EMd for internal communication, a memory 140, the signal processing device 170, a plurality of displays 180a to 180c, an audio output device 185, and a power supply 190.

The plurality of communication devices EMa to EMd may be disposed in a plurality of zones Z1 to Z4, respectively, in FIG. 2.

Meanwhile, the signal processing device 170 may be provided therein with a communication switch 736b for data communication with the respective communication devices EM1 to EM4.

The respective communication devices EM1 to EM4 may perform data communication with the plurality of sensor devices SN or the ECU 770.

Meanwhile, each of the plurality of sensor devices SN may include a camera 195, a lidar sensor 196, a radar sensor 197, or a position sensor 198.

The input device 110 may include a physical button or pad for button input or touch input.

Meanwhile, the input device 110 may include a microphone (not shown) for user voice input.

The transceiver 120 may wirelessly exchange data with a mobile terminal 800 or a server 900.

In particular, the transceiver 120 may wirelessly exchange data with a mobile terminal of a vehicle driver. Any of various data communication schemes, such as Bluetooth, Wi-Fi, WIFI Direct, and APIX, may be used as a wireless data communication scheme.

The transceiver 120 may receive weather information and road traffic state information, such as Transport Protocol Experts Group (TPEG) information, from a mobile terminal 800 or a server 900. To this end, the transceiver 120 may include a mobile communication device (not shown).

Meanwhile, the transceiver 120 may wirelessly exchange data with adjacent vehicles.

For example, the transceiver 120 may wirelessly exchange vehicle messages with adjacent vehicles using Vehicle-to-everything (V2X) communication.

The plurality of communication devices EM1 to EM4 may receive sensor data and the like from the electronic control unit (ECU) 770 or the sensor device SN or a zonal signal processing device 170Z, and may transmit the received sensor data to the signal processing device 170.

Here, the sensor data may include at least one of vehicle direction data, vehicle position data (global positioning system (GPS) data), vehicle angle data, vehicle speed data, vehicle acceleration data, vehicle inclination data, vehicle forward/backward movement data, battery data, fuel data, tire data, vehicle lamp data, vehicle internal temperature data, and vehicle internal humidity data.

The sensor data may be acquired from a heading sensor, a yaw sensor, a gyro sensor, a position sensor, a vehicle forward/backward movement sensor, a wheel sensor, a vehicle speed sensor, a car body inclination sensor, a battery sensor, a fuel sensor, a tire sensor, a steering-wheel-rotation-based steering sensor, a vehicle internal temperature sensor, or a vehicle internal humidity sensor.

Meanwhile, the position module may include a GPS module configured to receive GPS information or a position sensor 198.

Meanwhile, at least one of the plurality of communication devices EM1 to EM4 may transmit position information data sensed by the GPS module or the position sensor 198 to the signal processing device 170.

Meanwhile, at least one of the plurality of communication devices EM1 to EM4 may receive front image data of the vehicle, side-of-vehicle image data, rear image data of the vehicle, and obstacle-around-vehicle distance information from the camera 195, the lidar sensor 196, or the radar sensor 197, and may transmit the received information to the signal processing device 170.

The memory 140 may store various data necessary for overall operation of the vehicle display apparatus 100, such as programs for processing or control of the signal processing device 170.

For example, the memory 140 may store data about the hypervisor and first to third virtual machines executed by the hypervisor in the processor 175.

The audio output device 185 may convert an electrical signal from the signal processing device 170 into an audio signal, and may output the audio signal. To this end, the audio output device 185 may include a speaker.

The power supply 190 may supply power necessary to operate components under control of the signal processing device 170. In particular, the power supply 190 may receive power from a battery in the vehicle.

The signal processing device 170 may control the overall operation of each device in the vehicle display apparatus 100 or the vehicle 200.

For example, the signal processing device 170 may include a processor 175 configured to perform signal processing for the vehicle displays 180a and 180b.

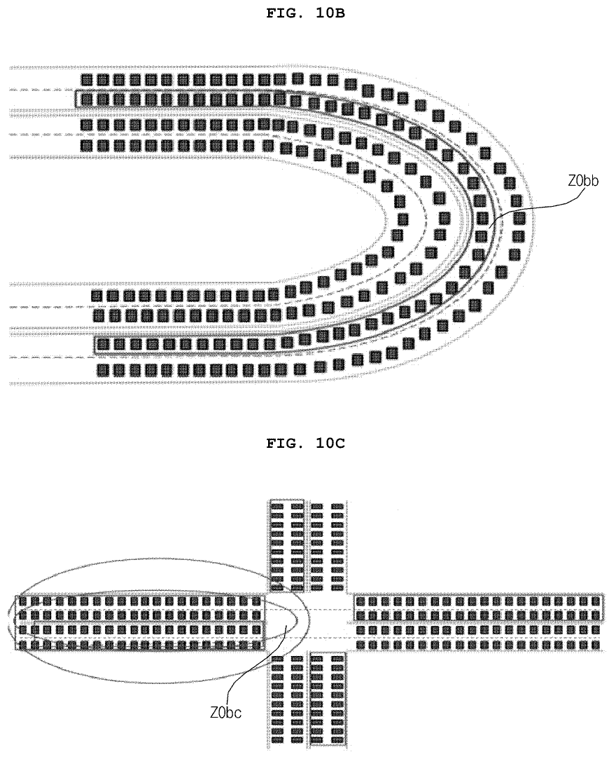

The processor 175 may execute the first to third virtual machines (not shown) on the hypervisor 505 (see FIG. 10) in the processor 175.

Among the first to third virtual machines (not shown) (see FIG. 10), the first virtual machine (not shown) may be called a server virtual machine, and the second and third virtual machines (not shown) and (not shown) may be called guest virtual machines.

For example, the first virtual machine (not shown) in the processor 175 may receive sensor data from the plurality of sensor devices, such as vehicle sensor data, position information data, camera image data, audio data, or touch input data, and may process and output the received sensor data.

As described above, the first virtual machine (not shown) may process most of the data, whereby 1:N data sharing may be achieved.

In another example, the first virtual machine (not shown) may directly receive and process CAN data, Ethernet data, audio data, radio data, USB data, and wireless communication data for the second and third virtual machines (not shown).

Further, the first virtual machine (not shown) may transmit the processed data to the second and third virtual machines (not shown).

Accordingly, only the first virtual machine (not shown), among the first to third virtual machines (not shown), may receive sensor data from the plurality of sensor devices, communication data, or external input data, and may perform signal processing, whereby load in signal processing by the other virtual machines may be reduced and 1:N data communication may be achieved, and therefore synchronization at the time of data sharing may be achieved.

Meanwhile, the first virtual machine (not shown) may be configured to write data in the shared memory 508, whereby the second virtual machine (not shown) and the third virtual machine (not shown) share the same data.

For example, the first virtual machine (not shown) may be configured to write vehicle sensor data, the position information data, the camera image data, or the touch input data in the shared memory 508, whereby the second virtual machine (not shown) and the third virtual machine (not shown) share the same data. Consequently, 1:N data sharing may be achieved.

Eventually, the first virtual machine (not shown) may process most of the data, whereby 1:N data sharing may be achieved.

Meanwhile, the first virtual machine (not shown) in the processor 175 may be configured to set the shared memory 508 based on the hypervisor 505 in order to transmit the same data to the second virtual machine (not shown) and the third virtual machine (not shown).

Meanwhile, the signal processing device 170 may process various signals, such as an audio signal, an image signal, and a data signal. To this end, the signal processing device 170 may be implemented in the form of a system on chip (SOC).

FIG. 5 is an exemplary block diagram of a vehicle control device according to an embodiment of the present disclosure.

Referring to FIG. 5, a vehicle control device 900 according to an embodiment of the present disclosure includes the transceiver or communication device 120.

Meanwhile, the vehicle control device 900 according to an embodiment of the present disclosure may further include the signal processing device 170.

The communication device 120 according to an embodiment of the present disclosure may wirelessly exchange vehicle messages with adjacent vehicles using Vehicle-to-everything (V2X) communication.

In this case, the communication device 120 according to an embodiment of the present disclosure filter vehicle messages based on road type information. Accordingly, the vehicle messages received from the adjacent vehicles may be efficiently filtered. Particularly, the vehicle messages received from the adjacent vehicles may be efficiently filtered based on the road type information.

Meanwhile, the communication device 120 may transmit vehicle messages, which are passed by filtering, to the signal processing device 170. As described above, by filtering the vehicle messages, only required vehicle messages may be transmitted to the signal processing device 170, thereby improving the efficiency of signal processing.

Meanwhile, the vehicle control device 900 according to an embodiment of the present disclosure may further include at least one display.

Meanwhile, the vehicle control device 900 according to an embodiment of the present disclosure may further include the steering driver 752, the brake driver 753, and the power source driver 754, the ECU 770, the plurality of sensor devices SN, or the like of FIG. 4.

Meanwhile, the vehicle control device 900 according to an embodiment of the present disclosure may further include the lamp driver 751, the suspension driver 756, the air conditioner driver 755, the window driver 758, and the seat driver 761, the plurality of communication devices EMa to EMd, or the like of FIG. 4.

In the drawing, the cluster display 180a and the AVN display 180b are illustrated as at least one display.

Meanwhile, the vehicle control device 900 may further include the plurality of zonal signal processing devices 170Z1 to 170Z4.

In this case, the signal processing device 170 is a high-performance centralized signal processing and control device including a plurality of CPUs 175, GPUs 178, NPUs 179, etc., and may be referred to as a High Performance Computing (HPC) signal processing device or a central signal processing device.

The plurality of zonal signal processing devices 170Z1 to 170Z4 and the signal processing device 170 may be connected via wired cables CB1 to CB4.

Meanwhile, the plurality of zonal signal processing devices 170Z1 to 170Z4 may be connected via wired cables CBa to CBd.

In this case, the wired cables CBa to CBd may include CAN communication cable or Ethernet communication cable, or PCI Express cable.

Meanwhile, the signal processing device 170 according to an embodiment of the present disclosure may include at least one processor 175, 178, and 177, and a storage device 925 having a large capacity.

For example, the signal processing device 170 according to an embodiment of the present disclosure may include central processors 175 and 177, a graphic processor 178, and a neural processor 179.

Meanwhile, sensor data may be transmitted from at least one of the plurality of zonal signal processing devices 170Z1 to 170Z4 to the signal processing device 170. Particularly, the sensor data may be stored in the storage device 925 in the signal processing device 170.

In this case, the sensor data may include at least one of camera data, lidar data, radar data, vehicle direction data, vehicle position data (global positioning system (GPS) data), vehicle angle data, vehicle speed data, vehicle acceleration data, vehicle inclination data, vehicle forward/backward movement data, battery data, fuel data, tire data, vehicle lamp data, vehicle internal temperature data, and vehicle internal humidity data.

In the drawing, an example is illustrated in which the camera data from the camera 195a and the lidar data from the lidar sensor 196 are input to a first zonal signal processing device 170Z1, and the camera data and the lidar data are transmitted to the signal processing device 170 via a second zonal signal processing device 170Z2 and a third zonal signal processing device 170Z3, and the like.

Meanwhile, data write speed or data read speed to write and read data to and from the storage device 925 is faster than a network speed when the sensor data is transmitted from at least one of the plurality of zonal signal processing devices 170Z1 to 170Z4 to the signal processing device 170, such that it is preferred to perform multi path routing so as to avoid bottlenecks in a network.

To this end, the signal processing device 170 according to an embodiment of the present disclosure may perform multi path routing based on Software Defined Network (SDN). Accordingly, stable network environment for data write and read operations may be ensured. Further, data may be transmitted to the storage device 925 by using multiple paths, such that data may be transmitted by dynamically changing a network configuration.

It is desirable that data communication between the plurality of zonal signal processing devices 170Z1 to 170Z4 and the signal processing device 170 in the vehicle control device 900 according to an embodiment of the present disclosure is peripheral component interconnect express communication in order to provide high band and low delay communication.

Meanwhile, the signal processing device 170 according to an embodiment of the present disclosure may receive a vehicle internal image from an internal camera 195i, and may perform signal processing on the vehicle internal image.

Meanwhile, the signal processing device 170 according to an embodiment of the present disclosure may receive a front image from a front camera 195a, and may perform signal processing on the front image.

FIG. 6 is an exemplary block diagram of a communication device according to an embodiment of the present disclosure.

Referring to FIG. 6, a communication device 100 according to an embodiment of the present disclosure includes an antenna ATa configured to receive an RF signal, an RF communication device 610 configured to receive vehicle messages from a plurality of adjacent external vehicles based on the RF signal from the antenna ATa, and a processor 670 configured to perform filtering of the vehicle messages based on road type information, receiver sensitivity information of the RF signal, wheel direction information, and speed information.

Accordingly, the vehicle messages received from the adjacent vehicles may be efficiently filtered. Particularly, the vehicle messages received from the adjacent vehicles may be efficiently filtered based on road type information.

Meanwhile, the RF communication device 610 may convert the RF signal based on V2X communication into a baseband signal. In this case, the V2X communication may be communication standards such as 3GPP, 4G, 5G, or IEEE.

Meanwhile, the RF communication device 610 may extract a pilot signal based on the baseband signal, may perform time interpolation based on the pilot signal, and may perform time interpolation or frequency interpolation based on the pilot signal.

Further, the RF communication device 610 may perform channel estimation after performing the time interpolation or frequency interpolation.

Meanwhile, the RF communication device 610 may receive vehicle messages from a plurality of adjacent external vehicles and transmit vehicle messages to the adjacent external vehicles, based on the V2X communication.

Meanwhile, the vehicle messages may include receiver sensitivity information of the RF signal, and location information, speed information and wheel direction information of a corresponding vehicle, and the like.

Meanwhile, a microcomputer 613 may be provided therein for the operation of the RF communication device 610. The microcomputer 613 may control conversion of the RF signal into the baseband signal or conversion of the baseband signal into the RF signal.

The processor 670 receives vehicle messages from the plurality of external vehicles via the RF communication device 610.

Then, the processor 670 filters the vehicle messages received from the RF communication device 610.

The processor 670 according to an embodiment of the present disclosure filters the vehicle messages based on road type information, receiver sensitivity information of the RF signal, wheel direction information, and speed information.

For example, the processor 670 may include or execute a V2X stack 674 for temporarily storing the vehicle messages received from the RF communication device 610, and a message filter 672 for filtering the vehicle messages from the V2X stack 674.

Meanwhile, the message filter 672 in the processor 670 may set a message passing zone based on the road type information, receiver sensitivity information of the RF signal, wheel direction information, and speed information, and may filter the vehicle messages based on the message passing zone. Accordingly, the vehicle messages received from the adjacent vehicles may be efficiently filtered.

Meanwhile, the message filter 672 in the processor 670 may pass vehicle messages from external vehicles included in the message passing zone, and may block vehicle messages from external vehicles not included in the message passing zone.

Meanwhile, the message filter 672 in the processor 670 may set priority levels based on the road type information, receiver sensitivity information of the RF signal, wheel direction information, and speed information, and may filter the vehicle messages based on the priority levels. Accordingly, the vehicle messages received from the adjacent vehicles may be efficiently filtered.

For example, the message filter 672 in the processor 670 may set a priority level of the speed information to a highest level and a priority level of the wheel direction information to a lowest level in the case in which the road type is a straight road or a curved road, and the message filter 672 in the processor 670 may set a priority level of the wheel direction information to a highest level and a priority level of the speed information to a lowest level in the case in which the road type is an intersection.

Meanwhile, the message filter 672 in the processor 670 may set a message passing zone based on the set priority levels, and to perform filtering of the vehicle messages based on the message passing zone.

Meanwhile, in the case in which the road type is a straight road or a curved road, the message filter 672 in the processor 670 may increase the message passing zone as a level of the speed information increases. Accordingly, the vehicle messages received from the adjacent vehicles may be efficiently filtered.

Meanwhile, in the case in which the road type is an intersection, the message filter 672 in the processor 670 may set a direction or location of the message passing zone based on the wheel direction information. Accordingly, the vehicle messages received from the adjacent vehicles may be efficiently filtered.

Meanwhile, the message filter 672 in the processor 670 may filter the vehicle messages in the case in which a utilization of the processor 670 is greater than or equal to a reference value.

For example, the message filter 672 in the processor 670 may block a first number of vehicle messages in the case in which a utilization of the processor 670 is a first level greater than or equal to the reference value, and may block a second number of vehicle messages in the case in which a utilization of the processor 670 is a second level greater than the first level, the second number being greater than the first number. Accordingly, the vehicle messages received from the adjacent vehicles may be efficiently filtered.

Meanwhile, the message filter 672 in the processor 670 may decrease the message passing zone as the utilization of the processor 670 increases. Accordingly, the vehicle messages received from the adjacent vehicles may be efficiently filtered.

Meanwhile, the RF communication device 610 may transmit vehicle message transmission interval to external vehicles based on the set message passing zone.

For example, the RF communication device 610 may control a transmission interval of the vehicle messages of the external vehicles to become longer as the size of the message passing zone decreases. Accordingly, the vehicle messages received from the adjacent vehicles may be efficiently filtered.

Meanwhile, the communication device 120 according to an embodiment of the present disclosure may further include an interface 620 configured to exchange data with the signal processing device 170.

Meanwhile, the processor 670 may set the message passing zone based on an application executed in the signal processing device 170.

Specifically, the processor 670 may change the message passing zone based on an application executed in the signal processing device 170 and a traveling direction of the vehicle.

For example, the processor 670 may change the message passing zone based on a traveling direction of the vehicle in the case in which an autonomous emergency steering (AES) control application is executed in the processor 175 of the signal processing device 170. Accordingly, the vehicle messages may be efficiently filtered based on the AES control application executed in the signal processing device 170.

In another example, the processor 670 may change a message passing zone to a rear area of the vehicle in the case in which an autonomous emergency braking (AEB) control application is executed in the processor 175 of the signal processing device 170. Accordingly, the vehicle messages may be efficiently filtered based on the AEB control application executed in the signal processing device 170.

Meanwhile, the communication device 120 according to an embodiment of the present disclosure may further include a memory 640 configured to store information related to operation of the processor 670.

Meanwhile, the communication device 120 according to an embodiment of the present disclosure may further include a second RF communication device 615 for mobile communication (e.g., 3G, 4G, 5G, etc.) with an external server and the like.

That is, the second RF communication device 615 may perform Vehicle-to-Cloud (V2C) communication or Vehicle-to-Network (V2N) communication.

Meanwhile, the second RF communication device 615 may convert the received RF signal into a baseband signal, and may transmit the baseband signal to the processor 670.

Meanwhile, the processor 670 in the communication device 120 according to another embodiment of the present disclosure filters vehicle messages based on road type information and a utilization of the processor 670. Accordingly, the vehicle messages received from the adjacent vehicles may be efficiently filtered based on the road type information and the utilization of the processor 670.

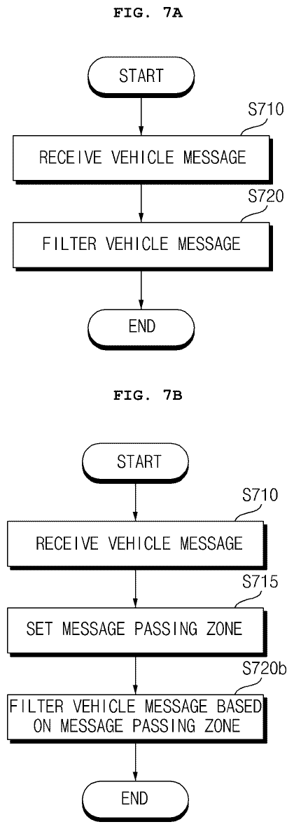

FIG. 7A is a flowchart illustrating a method of operating a communication device according to an embodiment of the present disclosure.

Referring to FIG. 7A, the communication device 120 according to an embodiment of the present disclosure receives vehicle messages (S710).

For example, the communication device 120 in a vehicle 100 may receive a plurality of vehicle messages from a plurality of external vehicles.

Particularly, the RF communication device 610 in the communication device 120 receives an RF signal based on V2X communication, and may extract vehicle messages from the RF signal.

Then, the processor 675 in the communication device 120 filters the plurality of vehicle messages received from the RF communication device 610 (S720).

Specifically, the processor 675 in the communication device 120 filters the plurality of vehicle messages based on road type information, receiver sensitivity information of the RF signal, wheel direction information, and speed information. Accordingly, the vehicle messages received from the adjacent vehicles may be efficiently filtered. Particularly, the vehicle messages received from the adjacent vehicles may be efficiently filtered based on the road type information.

Meanwhile, the processor 670 may pass acceptable vehicle messages and block unacceptable vehicle messages by using the message filter 672.

For example, the processor 670 may set priority levels based on the road type information, receiver sensitivity information of the RF signal, wheel direction information, and speed information, and may filter the vehicle messages based on the priority levels. Accordingly, the vehicle messages received from the adjacent vehicles may be efficiently filtered.

FIG. 7B is a flowchart illustrating a method of operating a communication device according to another embodiment of the present disclosure.

Referring to FIG. 7B, the communication device 120 according to another embodiment of the present disclosure receives vehicle messages (S710).

For example, the communication device 120 in a vehicle 100 may receive a plurality of vehicle messages from a plurality of external vehicles.

Particularly, the RF communication device 610 in the communication device 120 receives an RF signal based on V2X communication, and may extract vehicle messages from the RF signal.

Then, the processor 675 in the communication device 120 sets a message passing zone related to the vehicle messages (S715).

For example, the processor 675 in the communication device 120 may set the message passing zone based on road type information, receiver sensitivity information of the RF signal, wheel direction information, and speed information.

Then, the processor 675 in the communication device 120 filters the plurality of vehicle messages based on the set message passing zone (S720b).

Specifically, the processor 675 in the communication device 120 sets the message passing zone based on the road type information, receiver sensitivity information of the RF signal, wheel direction information, and speed information, and filters the plurality of vehicle messages based on the set message passing zone.

For example, the processor 675 in the communication device 120 may pass vehicle messages in the case in which the vehicle messages are received from external vehicles included in the message passing zone, and the processor 675 in the communication device 120 may block vehicle messages in the case in which the vehicle messages are received from external vehicles not included in the message passing zone. Accordingly, the vehicle messages received from the adjacent vehicles may be efficiently filtered.

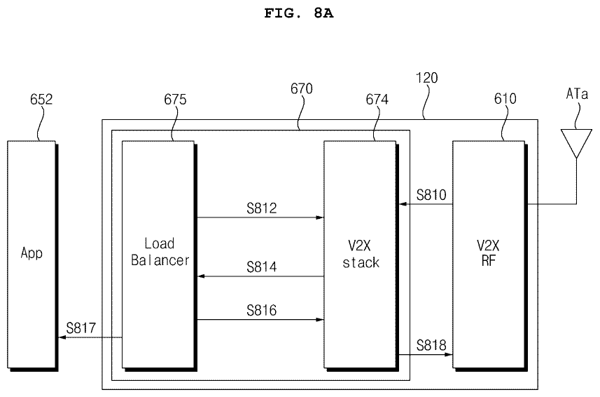

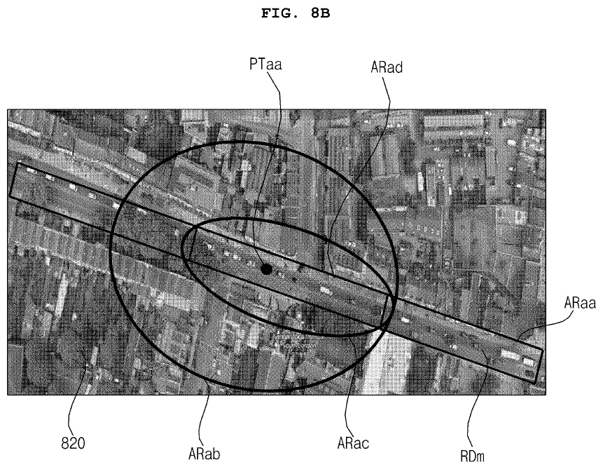

FIGS. 8A to 19D are diagrams referred to in the description of operation of FIGS. 7A and 7B.

FIG. 8A is a diagram referred to in the description of filtering vehicle messages. Particularly, filtering based on a MAC address in a PHY layer and a MAC layer as a hardware layer is illustrated.

Referring to FIG. 8A, the RF communication device 610 in the communication device 120 receives vehicle messages based on V2X communication from adjacent vehicles, and transmits the received vehicle messages to the V2X stack 674 in the processor 670 (S810).

For example, the RF communication device 610 may decode the received vehicle messages based on the hardware layer.

Specifically, the RF communication device 610 may decode the received vehicle messages based on the PHY layer or the MAC layer as an example of a hardware layer.

Then, the RF communication device 610 may transmit the hardware-decoded messages to the V2X stack 674 in the processor 670.

Meanwhile, the V2X stack 674 may decode the received vehicle messages. Particularly, the V2X stack 674 may decode the received vehicle messages based on software.

Specifically, the V2X stack 674 may decode the received vehicle messages based on the PHY layer and the MAC layer as an example of a hardware layer.

Meanwhile, the processor 670 in the communication device 120 may execute a load balancer 675, and the load balancer 675 may transmit navigation data or map data to the V2X stack 674 (S812).

In this case, the navigation data or the map data may be data stored in the memory 640 of the communication device 120.

Alternatively, the navigation data or the map data may be data received from the signal processing device 170 through the interface 620.

Meanwhile, the V2X stack 674 may perform map matching based on the decoded vehicle messages, the navigation data, or the map data.

Specifically, the V2X stack 674 may perform map matching on the decoded vehicle messages based on the navigation data or the map data.

Further, the V2X stack 674 may transmit map matching data on the decoded vehicle messages to the load balancer 675 (S814).

Then, the load balancer 675 may set a filtering target based on the map matching data.

Then, the load balancer 675 may transmit the filtering target information to the V2X stack 674 (S816).

Meanwhile, the V2X stack 674 or the message filter 672 may filter the vehicle messages based on the filtering target information.

For example, the V2X stack 674 or the message filter 672 may filter the vehicle messages based on road type information, receiver sensitivity information of the RF signal, wheel direction information, and speed information.

Meanwhile, the V2X stack 674 or the message filter 672 may pass acceptable vehicle messages and block unacceptable vehicle messages by using the message filter 672.

Meanwhile, the V2X stack 674 or the message filter 672 may set a message passing zone related to the vehicle messages, based on the map matching data.

Meanwhile, the V2X stack 674 or the message filter 672 may set a message passing zone based on the road type information, receiver sensitivity information of the RF signal, wheel direction information, and speed information, and may filter the vehicle messages based on the set message passing zone.

Meanwhile, the load balancer 675 may transmit the vehicle messages, which are passed based on filtering of the vehicle messages, to an application 652 executed in the processor 175 of the signal processing device 170 (S817).

Meanwhile, the V2X stack 674 may transmit a MAC address, corresponding to a result of blocking or passing the vehicle messages, and a transmission interval of the vehicle messages to the RF communication device 610 (S818).

Accordingly, the RF communication device 610 may transmit transmission interval information of the vehicle messages and the like to adjacent external vehicles.

Meanwhile, the RF communication device 610 may transmit transmission interval information of the vehicle messages based on the message passing zone.

For example, the RF communication device 610 may control a transmission interval of the vehicle messages of the external vehicles to become longer as the size of the message passing zone decreases. Accordingly, the vehicle messages received from the adjacent vehicles may be efficiently filtered.

FIG. 8B is a diagram illustrating map matching based on map data with respect to vehicles.

Referring to FIG. 8B, the processor 670 in the communication device 120 may determine a message passing zone ARad based on an area ARab which is based on receiver sensitivity information of the RF signal, a straight area ARaa in the case in which the road type is a straight road RDm, an area ARac based on map data, and a location PTaa of the vehicle 200.

For example, the processor 670 in the communication device 120 may determine a common area of the area ARab which is based on receiver sensitivity information of the RF signal, the straight area ARaa in the case in which the road type is the straight road RDm, the area ARac based on map data, and the location PTaa of the vehicle 200 to be the message passing zone ARad.

Further, the processor 670 in the communication device 120 may pass only vehicle messages received in the message passing zone ARad, and may block vehicle messages received outside the message passing zone ARad. Accordingly, the vehicle messages received from the adjacent vehicles may be efficiently filtered.

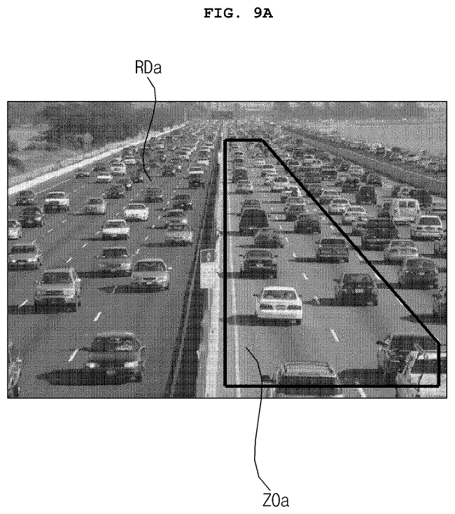

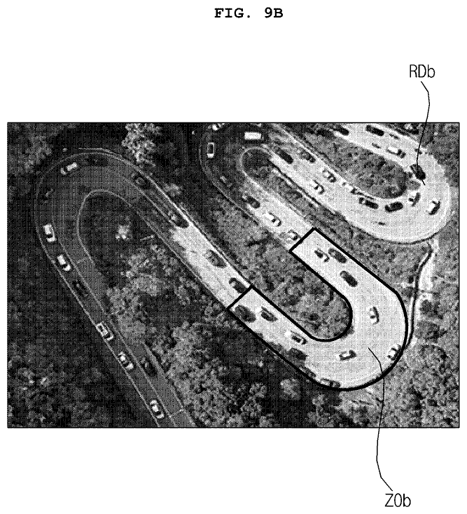

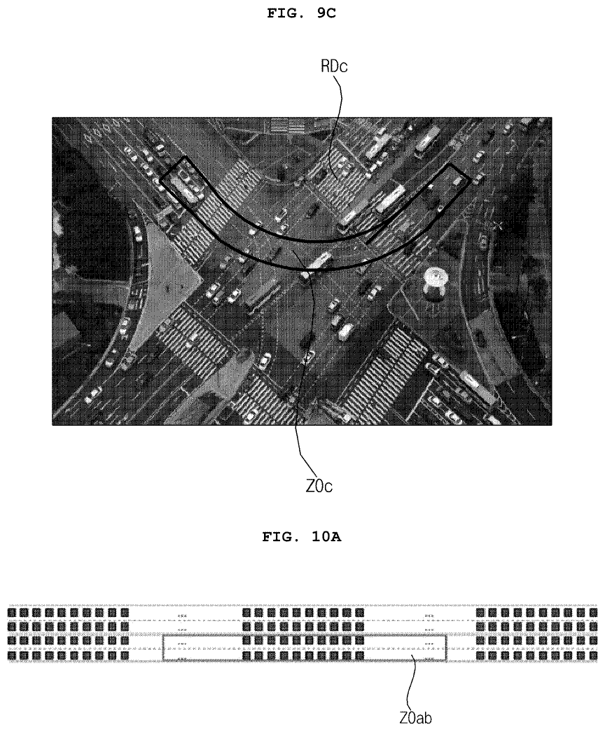

FIG. 9A is a diagram illustrating an example in which a road type is a straight road.

Referring to FIG. 9A, the processor 670 in the communication device 120 may set a message passing zone based on road type information, receiver sensitivity information of the RF signal, wheel direction information, and speed information.

Particularly, in the case in which the road type is a straight road RDa, the processor 670 in the communication device 120 may set a rectangular area Zoa as the message passing zone, as illustrated herein.

That is, the processor 670 in the communication device 120 may pass vehicle messages from external vehicles in the rectangular area Zoa, and may block vehicle messages from external vehicles outside the rectangular area Zoa.

Accordingly, the vehicle messages received from the adjacent vehicles on the straight road may be efficiently filtered.

FIG. 9B is a diagram illustrating an example in which a road type is a curved road.

Referring to FIG. 9B, the processor 670 in the communication device 120 may set a curved area Zob as a message passing zone in the case in which the road type is a curved road RDb.

That is, the processor 670 in the communication device 120 may pass vehicle messages from external vehicles in the curved area Zob, and may block vehicle messages from external vehicles outside the curved area Zob.

Accordingly, the vehicle messages received from the adjacent vehicles on the curved road may be efficiently filtered.

FIG. 9C is a diagram illustrating an example in which a road type is an intersection.

Referring to FIG. 9C, the processor 670 in the communication device 120 may set an intersection area Zoc as a message passing zone in the case in which the road type is an intersection RDc.

That is, the processor 670 in the communication device 120 may pass vehicle messages from external vehicles in the intersection area Zoc, and may block vehicle messages from external vehicles outside the intersection area Zoc.

Accordingly, the vehicle messages received from the adjacent vehicles at the intersection may be efficiently filtered.

FIG. 10A is a diagram illustrating another example in which a road type is a straight road.

Referring to FIG. 10A, in the case in which the road type is a straight road, the processor 670 in the communication device 120 may set a rectangular area Zoab as a message passing zone, as illustrated herein.

That is, the processor 670 in the communication device 120 may pass vehicle messages from external vehicles in the rectangular area Zoab, and may block vehicle messages from external vehicles outside the rectangular area Zoab.

Accordingly, the vehicle messages received from the adjacent vehicles on the straight road may be efficiently filtered.

FIG. 10B is a diagram illustrating another example in which a road type is a curved road.

Referring to FIG. 10B, the processor 670 in the communication device 120 may set a curved area Zobb as a message passing zone in the case in which the road type is a curved road.

That is, the processor 670 in the communication device 120 may pass vehicle messages from external vehicles in the curved area Zobb, and may block vehicle messages from external vehicles outside the curved area Zobb.

Accordingly, the vehicle messages received from the adjacent vehicles on the curved road may be efficiently filtered.

FIG. 10C is a diagram illustrating another example in which a road type is an intersection.

Referring to FIG. 10C, the processor 670 in the communication device 120 may set an intersection area Zobc as a message passing zone in the case in which the road type is an intersection RDc.

That is, the processor 670 in the communication device 120 may pass vehicle messages from external vehicles in the intersection area Zobc, and may block vehicle messages from external vehicles outside the intersection area Zobc.

Accordingly, the vehicle messages received from the adjacent vehicles at the intersection may be efficiently filtered.

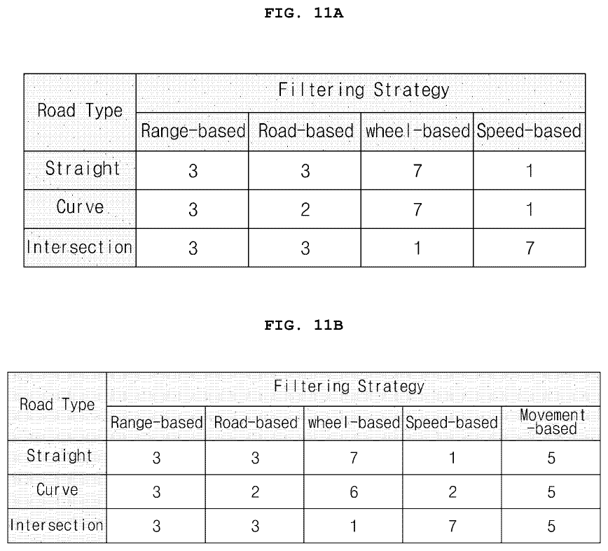

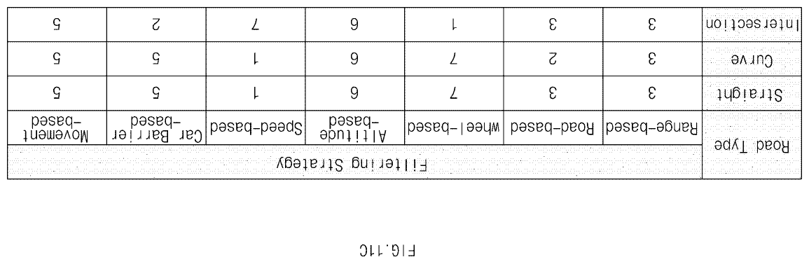

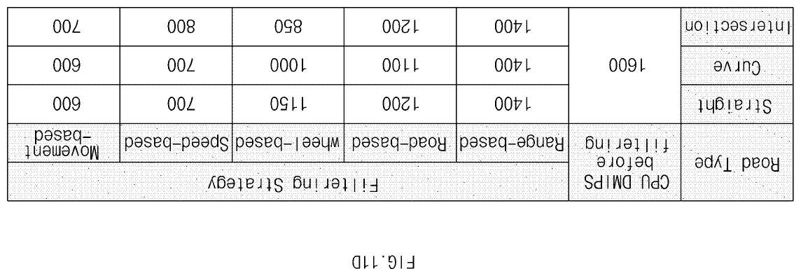

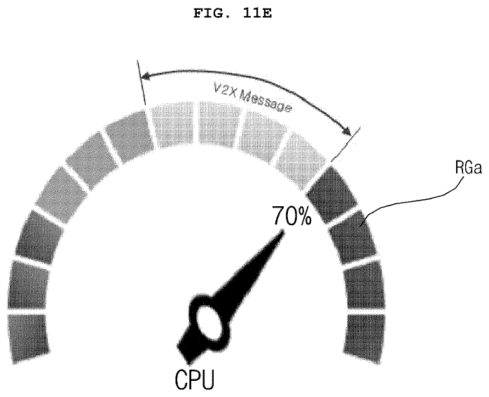

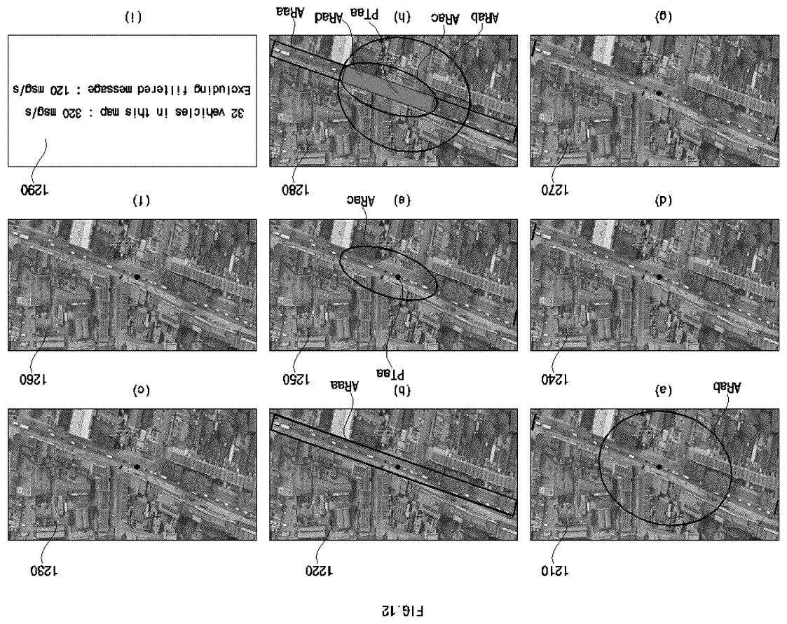

FIGS. 11A to 11E are diagrams referred to in the description of operation of a processor in a communication device.

FIG. 11A is a diagram illustrating an example of setting priority levels.

Referring to FIG. 11A, the processor 670 in the communication device 120 may set priority levels based on road type information, receiver sensitivity information of the RF signal, wheel direction information, and speed information, and may filter vehicle messages based on the priority levels.

In this case, the receiver sensitivity information of the RF signal may correspond to frequency range information.

For example, the processor 670 in the communication device 120 may set a priority level of the speed information to a highest level and a priority level of the wheel direction information to a lowest level in the case in which the road type is a straight road or a curved road, and the processor 670 in the communication device 120 may set a priority level of the wheel direction information to a highest level and a priority level of the speed information to a lowest level in the case in which the road type is an intersection. Accordingly, the vehicle messages received from the adjacent vehicles may be filtered adaptively according to the road type.

Meanwhile, in the case in which the road type is a straight road, the processor 670 in the communication device 120 may set a priority level of the speed information to “1” which is a highest level and a priority level of the wheel direction information to “7” which is a lowest level.

Meanwhile, the processor 670 in the communication device 120 may set priority levels based on road type information, receiver sensitivity information of the RF signal, wheel direction information, speed information, and road information, and may filter vehicle messages based on the priority levels.

Meanwhile, in the case in which the road type is a straight road, the processor 670 in the communication device 120 may set a priority level of the receiver sensitivity information of the RF signal and a priority level of the road information to the same level of “3”.

Meanwhile, in the case in which the road type is a curved road, the processor 670 in the communication device 120 may set a priority level of the speed information to “1” which is a highest level and a priority level of the wheel direction information to “7” which is a lowest level.

Meanwhile, in the case in which the road type is a curved road, the processor 670 in the communication device 120 may set a priority level of the receiver sensitivity information of the RF signal to “2” and a priority level of the road information to “3”, so that the priority level of the receiver sensitivity information of the RF signal may be higher than the priority level of the road information.

In the case in which the road type is an intersection, the processor 670 in the communication device 120 may set a priority level of the speed information to “7” which is a lowest level and a priority level of the wheel direction information to “1” which is a highest level.

Meanwhile, in the case in which the road type is an intersection, the processor 670 in the communication device 120 may set a priority level of the receiver sensitivity information of the RF signal and a priority level of the road information to the same level of “3”.

FIG. 11B is a diagram illustrating another example of setting priority levels.

Referring to FIG. 11B, there is a difference from FIG. 11A in that speed variation information is further included in FIG. 11B.

Meanwhile, in the case in which the road type is a straight road, the processor 670 in the communication device 120 may set a priority level of the speed information to “1” which is a highest level and a priority level of the wheel direction information to “7” which is a lowest level and may set a priority level of the receiver sensitivity information of the RF signal and a priority level of the road information to the same level of “3”.

Meanwhile, in the case in which the road type is a straight road, the processor 670 in the communication device 120 may set a priority level of the speed variation information to “5”, which is lower than the priority level of the receiver sensitivity information of the RF signal and the priority level of the road information.

Meanwhile, in the case in which the road type is a curved road, the processor 670 in the communication device 120 may set a priority level of the speed information to “2” which is a highest level and a priority level of the wheel direction information to “6” which is a lowest level, may set a priority level of the road information to “2” which is the same level as the priority level of the speed information, and may set a priority level of the receiver sensitivity information of the RF signal to “3” and a priority level of the speed variation information to “5”.

Meanwhile, in the case in which the road type is an intersection, the processor 670 in the communication device 120 may set a priority level of the speed information to “7” which is a lowest level and a priority level of the wheel direction information to “1” which is a highest level, and may set a priority level of the road information and a priority level of the receiver sensitivity information of the RF signal and to “3” and a priority level of the speed variation information to “5”.

FIG. 11C is a diagram illustrating another example of setting priority levels.

Referring to FIG. 11C, there is a difference from FIG. 11B in that altitude information and traffic congestion information are further included in FIG. 11C.

Meanwhile, in the case in which the road type is a straight road, the processor 670 in the communication device 120 may set a priority level of the receiver sensitivity information of the RF signal, a priority level of the road information, a priority level of the wheel direction information, a priority level of the altitude information, a priority level of the speed information, a priority level of the traffic congestion information, and a priority level of the speed variation information to “3,” “3,” “7,” “6,” “1,” “5,” and “5,” respectively.

Meanwhile, in the case in which the road type is a curved road, the processor 670 in the communication device 120 may set a priority level of the receiver sensitivity information of the RF signal, a priority level of the road information, a priority level of the wheel direction information, a priority level of the altitude information, a priority level of the speed information, a priority level of the traffic congestion information, and a priority level of the speed variation information to “3,” “2,” “7,” “6,” “1,” “5,” and “5,” respectively.

Particularly, in the case in which the road type is a straight road or a curved road, the processor 670 in the communication device 120 may set a priority level of the traffic congestion information and a priority level of the speed variation information to the same level.

Meanwhile, in the case in which the road type is an intersection, the processor 670 in the communication device 120 may set a priority level of the receiver sensitivity information of the RF signal, a priority level of the road information, a priority level of the wheel direction information, a priority level of the altitude information, a priority level of the speed information, a priority level of the traffic congestion information, and a priority level of the speed variation information to “3,” “3,” “1,” “6,” “7,” “2,” and “5,” respectively.

Particularly, in the case in which the road type is an intersection, the processor 670 in the communication device 120 may set a priority level of the traffic congestion information to a higher level than a priority level of the speed variation information.

In addition, in the case in which the road type is an intersection, the processor 670 in the communication device 120 may set a priority level of the traffic congestion information to a higher level than a priority level of the receiver sensitivity information of the RF signal and a priority level of the road information.

FIG. 11D is a diagram illustrating an example of filtering vehicle messages.

Referring to FIG. 11D, the processor 670 in the communication device 120 may perform filtering based on each of receiver sensitivity information of the RF signal, road information, wheel direction information, speed information, and speed variation information, for each road type.

For example, in the case in which the road type is a straight road, the processor 670 in the communication device 120 may pass only 1400 messages out of 1600 messages based on the receiver sensitivity information of the RF signal, may pass only 1200 messages out of 1400 messages based on the road information, may pass only 1150 messages out of 1200 messages based on the wheel direction information, may pass only 700 messages out of 1150 messages based on the speed information, and may pass only 600 messages out of 700 messages based on the speed variation information.

In another example, in the case in which the road type is a curved road, the processor 670 in the communication device 120 may pass only 1400 messages out of 1600 messages based on the receiver sensitivity information of the RF signal, may pass only 1100 messages out of 1400 messages based on the road information, may pass only 1000 messages out of 1100 messages based on the wheel direction information, may pass only 700 messages out of 1000 messages based on the speed information, and may pass only 600 messages out of 700 messages based on the speed variation information.

That is, the processor 670 in the communication device 120 may block a highest number of messages based on the speed information in the case in which the road type is a straight road or a curved road, thereby efficiently filtering the messages based on the speed information.

In yet another example, in the case in which the road type is an intersection, the processor 670 in the communication device 120 may pass only 1400 messages out of 1600 messages based on the receiver sensitivity information of the RF signal, may pass only 1200 messages out of 1400 messages based on the road information, may pass only 850 messages out of 1200 messages based on the wheel direction information, may pass only 800 messages out of 850 messages based on the speed information, and may pass only 700 messages out of 800 messages based on the speed variation information.

That is, the processor 670 in the communication device 120 may block a highest number of messages based on the wheel direction information in the case in which the road type is an intersection, thereby efficiently filtering the messages based on the wheel direction information.

Meanwhile, the processor 670 in the communication device 120 may block a smaller number of messages out of a total number of messages in the case in which the road type is an intersection than in the case in which the road type is a straight road or a curved road.

That is, the processor 670 in the communication device 120 may pass a greater number of messages out of a total number of messages in the case in which the road type is an intersection than in the case in which the road type is a straight road or a curved road.

That is, more information is required in the case of the intersection, such that the vehicle messages may be filtered adaptively.

FIG. 11E is a diagram illustrating an example of filtering based on a utilization of the processor.

Referring to FIG. 11E, the processor 670 in the communication device 120 may filter vehicle messages in the case in which a utilization of the processor 670 is greater than or equal to a reference value.

That is, in the case in which a utilization of the processor 670 is greater than or equal to a reference value, the processor 670 in the communication device 120 may filter vehicle messages based on road type information, receiver sensitivity information of the RF signal, wheel direction information, and speed information. Accordingly, the vehicle messages received from the adjacent vehicles may be efficiently filtered.

In the drawing, 70% is given as an example of the reference value.

For example, in the case in which a utilization of the processor 670 is greater than or equal to the reference value as illustrated herein, the processor 670 in the communication device 120 may filter vehicle messages based on road type information, receiver sensitivity information of the RF signal, wheel direction information, and speed information. Accordingly, the vehicle messages received from the adjacent vehicles may be efficiently filtered.

Meanwhile, the processor 670 may block a first number of vehicle messages in the case in which a utilization of the processor 670 is a first level, and may block a second number of vehicle messages in the case in which a utilization of the processor is a second level greater than the first level, the second number being greater than the first number.

For example, the processor 670 may pass only 600 messages while blocking 1000 messages out of 1600 messages in the case in which a utilization of the processor 670 is 75%, and may pass only 400 messages while blocking 1200 messages out of 1600 messages in the case in which a utilization of the processor 670 is 80%.

Meanwhile, the processor 670 in the communication device 120 may not filter the vehicle messages in the case in which a utilization of the processor 670 is less than the reference value.

For example, the processor 670 in the communication device 120 may not filter the vehicle messages in the case in which a utilization of the processor 670 is less than 70%.

Alternatively, the processor 670 in the communication device 120 may filter the vehicle messages in the case in which a utilization of the processor 670 is within a reference range.

That is, in the case in which a utilization of the processor 670 is within a reference range, the processor 670 in the communication device 120 may filter the vehicle messages based on road type information, receiver sensitivity information of the RF signal, wheel direction information, and speed information. Accordingly, the vehicle messages received from the adjacent vehicles may be efficiently filtered.

In this case, the reference range may be 40% to 70%.

Meanwhile, the processor 670 in the communication device 120 may not filter the vehicle messages in the case in which a utilization of the processor 670 falls outside the reference range and is below the lower limit of 40%.

Meanwhile, the processor 670 in the communication device 120 may reduce a utilization of the processor 670 in the case in which a utilization of the processor 670 falls outside the reference range and exceeds the upper limit of 70%.

For example, in the case in which a utilization of the processor 670 falls outside the reference range and exceeds the upper limit, the processor 670 in the communication device 120 may increase the number of filtering factors, so as to increase the number of blocked messages.

For example, in the case in which a utilization of the processor 670 falls outside the reference range and exceeds the upper limit, the processor 670 may filter the vehicle messages based further on a turn signal, altitude information, traffic congestion information, and speed variation information.

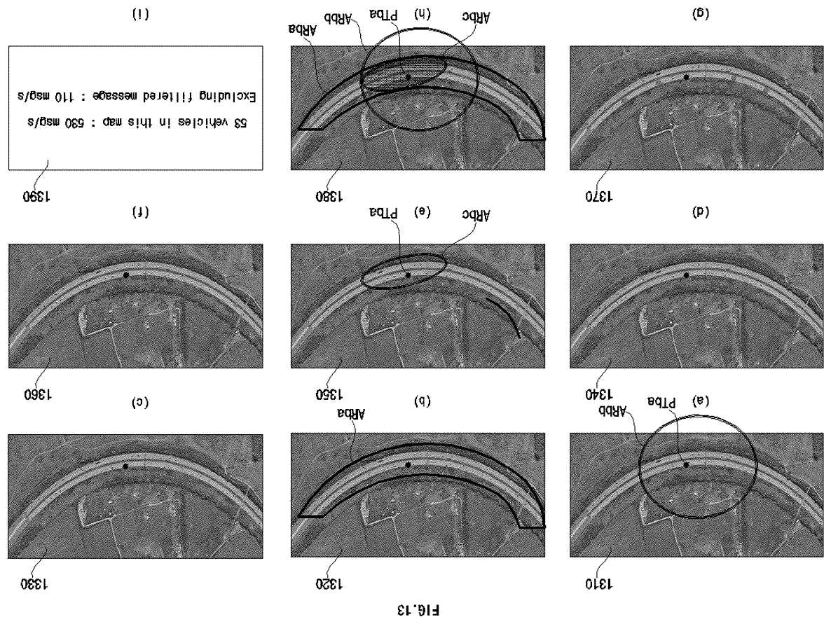

FIG. 12 is a diagram illustrating an example of filtering vehicle messages on a straight road.

Referring to FIG. 12, in the case in which a road type is a straight road, the processor 670 in the communication device 120 may determine a message passing zone ARad based on an area ARab that is based on receiver sensitivity information of an RF signal in an image 1210, a straight area ARaa based on road information in an image 1220, an area based on a turn-on signal in an image 1230, an area based on altitude information in an image 1240, an area ARac based on speed information in an image 1250, an area based on traffic congestion information in an image 1260, and an area based on speed variation information in an image 1270.

As a result, by combining the receiver sensitivity information of the RF signal, the road information, the wheel direction information, the altitude information, the speed information, the traffic congestion information, and the speed variation information, the processor 670 in the communication device 120 may determine a common area ARad of the area ARab, the area ARaa, and the area ARac in the image 1280 to be a message passing zone. In this case, the common area ARad desirably includes a vehicle location PTaa.

For example, upon receiving 320 vehicle messages from 32 vehicles in the area ARab, the processor 670 in the communication device 120 may pass only 200 messages in the message passing zone ARad while blocking 120 messages received outside the message passing zone ARad. Accordingly, the vehicle messages received from the adjacent vehicles may be efficiently filtered.

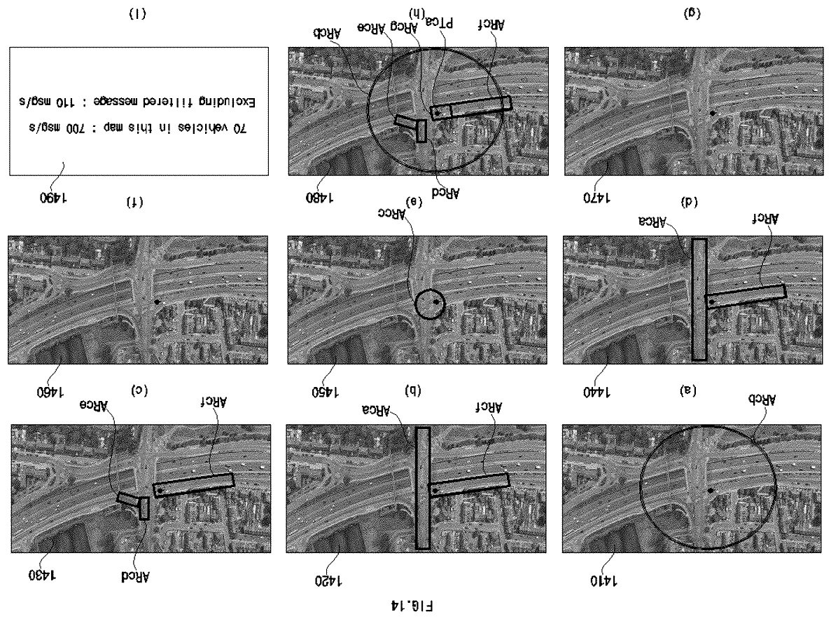

FIG. 13 is a diagram illustrating an example of filtering vehicle messages on a curved road.

Referring to FIG. 13, in the case in which a road type is a curved road, the processor 670 in the communication device 120 may determine a message passing zone ARbd based on an area ARbb that is based on receiver sensitivity information of an RF signal in an image 1310, a curved area ARba based on road information in an image 1320, an area based on a turn-on signal in an image 1330, an area based on altitude information in an image 1340, an area ARbc based on speed information in an image 1350, an area based on traffic congestion information in an image 1360, and an area based on speed variation information in an image 1370.

As a result, by combining the receiver sensitivity information of the RF signal, the road information, the wheel direction information, the altitude information, the speed information, the traffic congestion information, and the speed variation information, the processor 670 in the communication device 120 may determine a common area ARbc of the area ARbb, the area ARba, and the area ARbc in the image 1380 to be a message passing zone. In this case, the common area ARbc desirably includes a vehicle location PTba.

For example, upon receiving 530 vehicle messages from 53 vehicles in the area ARbb, the processor 670 in the communication device 120 may pass only 420 messages in the message passing zone ARad while blocking 110 messages received outside the message passing zone ARbc. Accordingly, the vehicle messages received from the adjacent vehicles may be efficiently filtered.

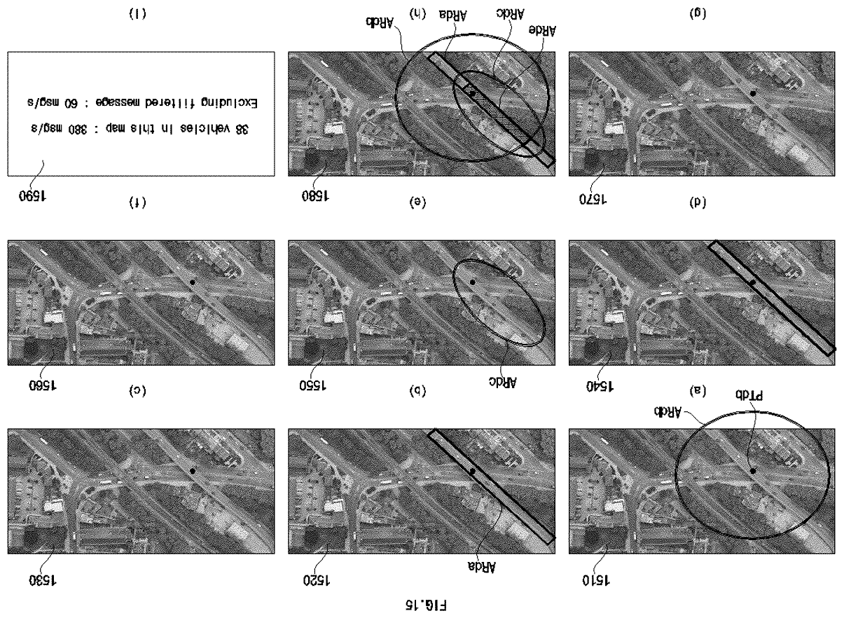

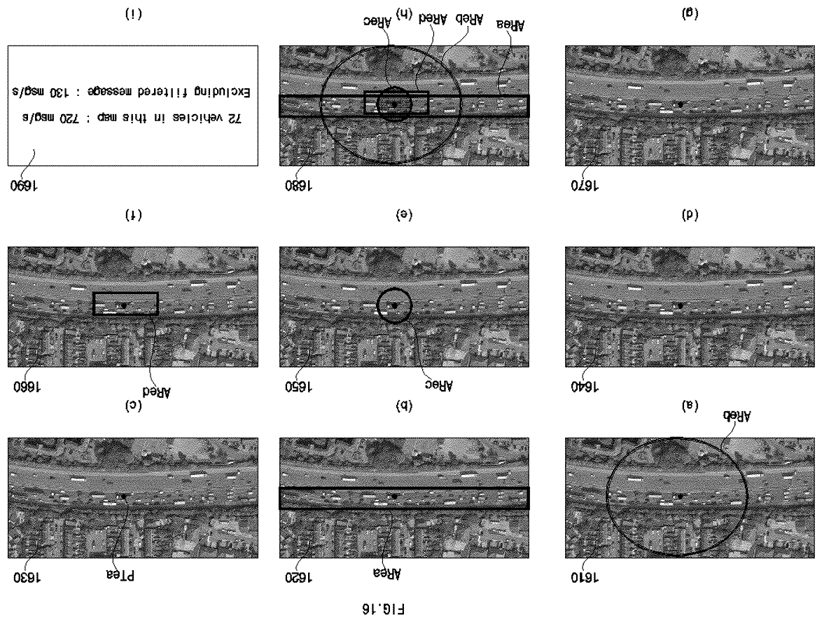

FIG. 14 is a diagram illustrating an example of filtering vehicle messages at an intersection.

Referring to FIG. 14, in the case in which a road type is an intersection, the processor 670 in the communication device 120 may determine message passing zones ARcd, ARce, and ARcg based on an area ARcb that is based on receiver sensitivity information of an RF signal in an image 1410, areas ARca and ARcf based on road information in an image 1420, areas ARcd, ARce, and ARcf based on turn-on signals in an image 1430, areas ARca and ARcf based on altitude information in an image 1440, an area ARcc based on speed information in an image 1450, an area based on traffic congestion information in an image 1460, and an area based on speed variation information in an image 1470.

In this case, the message passing zones ARcd, ARce, and ARcg desirably include a vehicle location PTba.

For example, upon receiving 700 vehicle messages from 70 vehicles in the area ARcb, the processor 670 in the communication device 120 may pass only 590 messages in the message passing zones ARcd, ARce, and ARcg while blocking 110 messages received outside the message passing zones ARcd, ARce, and ARcg. Accordingly, the vehicle messages received from the adjacent vehicles may be efficiently filtered.

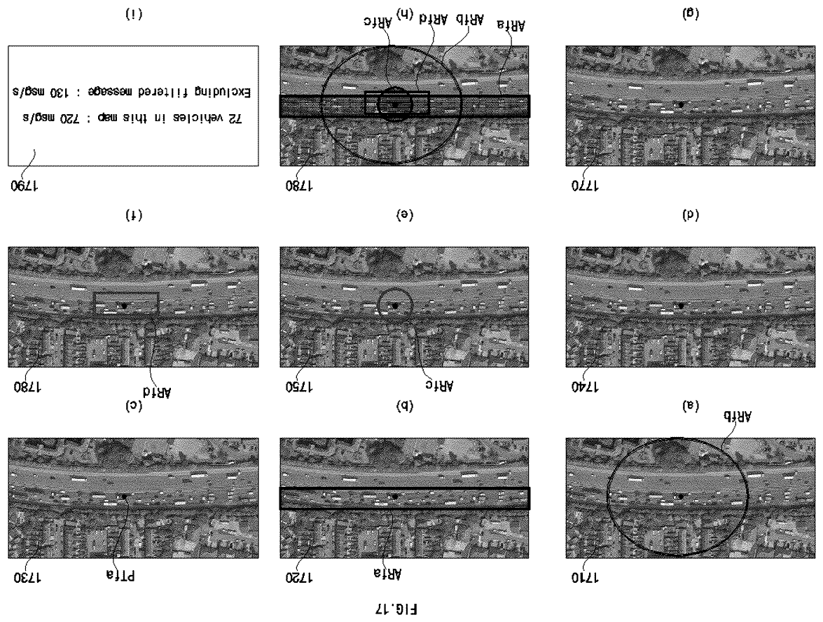

FIG. 15 is a diagram illustrating another example of filtering vehicle messages at an intersection.

Referring to FIG. 15, in the case in which a road type is an intersection, the processor 670 in the communication device 120 may determine a message passing zone ARdd based on an area ARdb that is based on receiver sensitivity information of an RF signal in an image 1510, a straight area ARda based on road information in an image 1520, an area based on a turn-on signal in an image 1530, an area based on altitude information in an image 1540, an area ARdc based on speed information in an image 1550, an area based on traffic congestion information in an image 1560, and an area based on speed variation information in an image 1570.

As a result, by combining the receiver sensitivity information of the RF signal, the road information, the wheel direction information, the altitude information, the speed information, the traffic congestion information, and the speed variation information, the processor 670 in the communication device 120 may determine a common area ARde of the area ARdb, the area ARda, and the area ARdc in the image 1580 to be a message passing zone. In this case, the common area ARde desirably includes a vehicle location PTdb.

For example, upon receiving 380 vehicle messages from 38 vehicles in the area ARdb, the processor 670 in the communication device 120 may pass only 320 messages in the message passing zone ARdd while blocking 60 messages received outside the message passing zone ARdd. Accordingly, the vehicle messages received from the adjacent vehicles may be efficiently filtered.

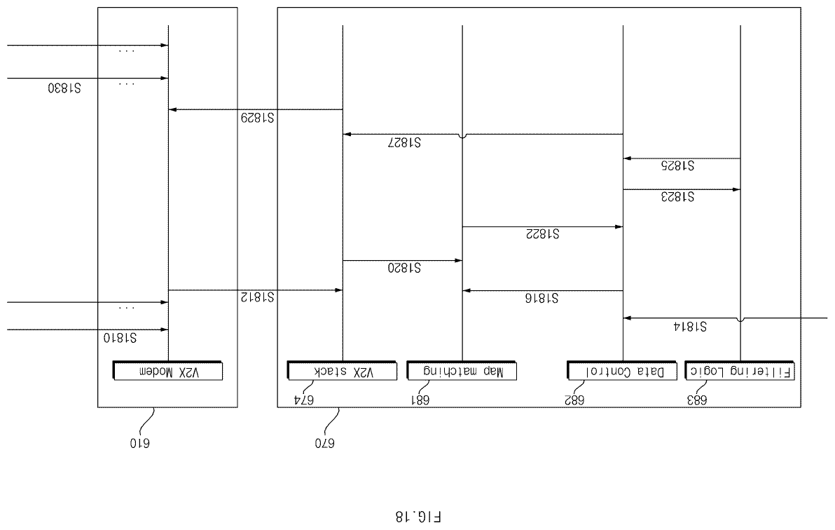

FIG. 16 is a diagram illustrating another example of filtering vehicle messages on a straight road.

Referring to FIG. 16, in the case in which a road type is a straight road, the processor 670 in the communication device 120 may determine a message passing zone ARed based on an area AReb that is based on receiver sensitivity information of an RF signal in an image 1610, a straight area ARea based on road information in an image 1620, an area based on a turn-on signal in an image 1630, an area based on altitude information in an image 1640, an area ARec based on speed information in an image 1650, an area ARed based on traffic congestion information in an image 1660, and an area based on speed variation information in an image 1670.

As a result, by combining the receiver sensitivity information of the RF signal, the road information, the wheel direction information, the altitude information, the speed information, the traffic congestion information, and the speed variation information, the processor 670 in the communication device 120 may determine a common area ARed of the area AReb, the area ARea, the area ARec, and the area ARed to be a message passing zone. In this case, the common area ARed desirably includes a vehicle location PTea.

For example, upon receiving 720 vehicle messages from 72 vehicles in the area AReb, the processor 670 in the communication device 120 may pass only 590 messages in the message passing zone ARed while blocking 130 messages received outside the message passing zone ARed. Accordingly, the vehicle messages received from the adjacent vehicles may be efficiently filtered.

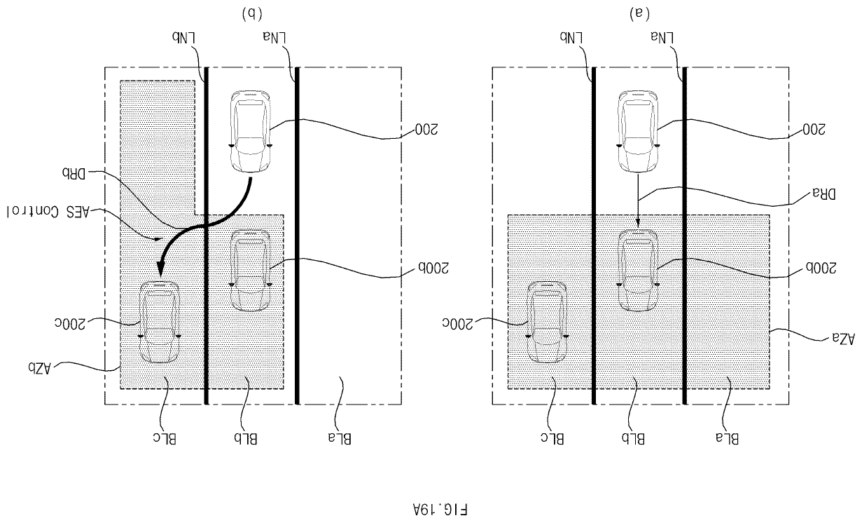

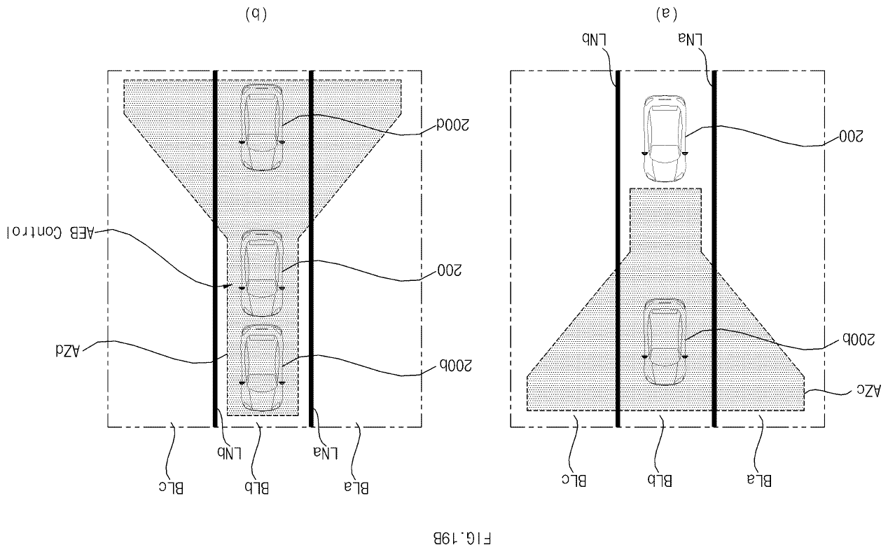

FIG. 17 is a diagram illustrating another example of filtering vehicle messages on a straight road.

Referring to FIG. 17, in the case in which a road type is a straight road, the processor 670 in the communication device 120 may determine a message passing zone ARfd based on an area ARfb that is based on receiver sensitivity information of an RF signal in an image 1710, a straight area ARfa based on road information in an image 1720, an area based on a turn-on signal in an image 1730, an area based on altitude information in an image 1740, an area ARfc based on speed information in an image 1750, an area ARfd based on traffic congestion information in an image 1760, and an area based on speed variation information in an image 1770.

As a result, by combining the receiver sensitivity information of the RF signal, the road information, the wheel direction information, the altitude information, the speed information, the traffic congestion information, and the speed variation information, the processor 670 in the communication device 120 may determine a common area ARfd of the area ARfb, the area ARfa, the area ARfc, and the area ARfd to be a message passing zone. In this case, the common area ARfd desirably includes a vehicle location PTfa.

For example, upon receiving 720 vehicle messages from 72 vehicles in the area ARfb, the processor 670 in the communication device 120 may pass only 590 messages in the message passing zone ARfd while blocking 130 messages received outside the message passing zone ARfd. Accordingly, the vehicle messages received from the adjacent vehicles may be efficiently filtered.

Meanwhile, to sum up with reference to FIGS. 12 to 17, the processor 670 may set priority levels based on the road type information, receiver sensitivity information of the RF signal, wheel direction information, and speed information.

That is, the processor 670 may set the message passing zone based on the road type information, receiver sensitivity information of the RF signal, wheel direction information, and speed information.

Meanwhile, the processor 670 may set priority levels based further on the turn-on signal, traffic congestion information, and speed variation information, in addition to the road type information, receiver sensitivity information of the RF signal, wheel direction information, and speed information.

That is, the processor 670 may set the message passing zone based further on the turn-on signal, traffic congestion information, and speed variation information, in addition to the road type information, receiver sensitivity information of the RF signal, wheel direction information, and speed information. Accordingly, the vehicle messages received from the adjacent vehicles may be efficiently filtered.

Meanwhile, the processor 670 may decrease the message passing zone as a congestion level based on the traffic congestion information increases or a speed variation of the speed variation information decreases.

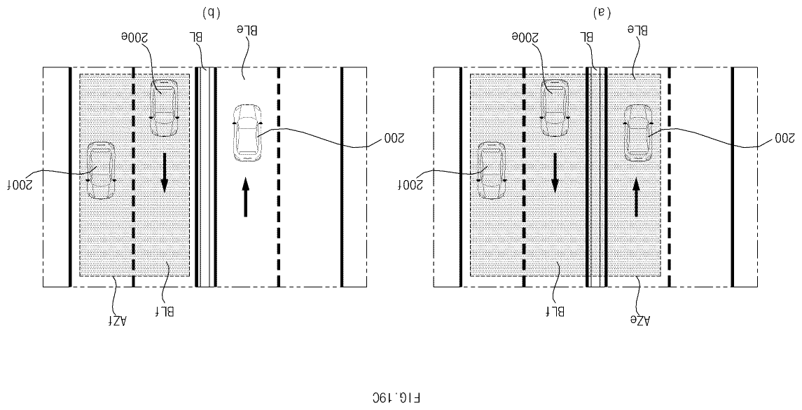

FIG. 18 is a flowchart illustrating a method of operating a processor in a communication device according to an embodiment of the present disclosure.

Referring to FIG. 18, the RF communication device 610 receives vehicle messages from adjacent external vehicles (S1810).

Then, the RF communication device 610 transmits the vehicle messages to the V2X stack 674 in the processor 670 (S1812).

Meanwhile, a data control 682 in the processor 670 receives map data or vehicle data (S1814).

For example, the data control 682 in the processor 670 receives map data or vehicle data from the signal processing device 170 through the interface 620.

Then, the data control 682 in the processor 670 transmits the map data or vehicle data to map matching 681 in the processor 670 (S1816).

Meanwhile, the V2X stack 674 in the processor 670 may transmit V2X object to the map matching 681 in the processor 670 (S1820).

Then, the map matching 681 in the processor 670 may transmit the V2X object, which is map-matched, to the data control 682 in the processor 670 (S1822).

Subsequently, the data control 682 in the processor 670 requests a filter logic 683 in the processor 670 to check a vehicle ID and a filter to be applied (S1823).

Then, the filter logic 683 in the processor 670 may transmit information related to the vehicle ID to the data control 682 (S1825).

Then, the data control 682 in the processor 670 may transmit filtering criteria to the V2X stack 674 in the processor 670 (S1827).

Next, the V2X stack 674 in the processor 670 may perform MAC-based hardware filtering based on the filtering criteria (S1829).

Then, the RF communication device 610 may transmit transmission interval information of the vehicle messages based on the filtering criteria to external vehicles.

Accordingly, the RF communication device 610 may receive, from adjacent external vehicles, vehicle messages based on the transmission interval information of the vehicle messages based on the filtering criteria (S1830).

For example, while receiving 1000 messages per second in operation 1810 (S1810), the RF communication device 610 may receive only 300 messages per second in operation 1830 (S1830). Accordingly, the vehicle messages received from the adjacent vehicles may be efficiently filtered.

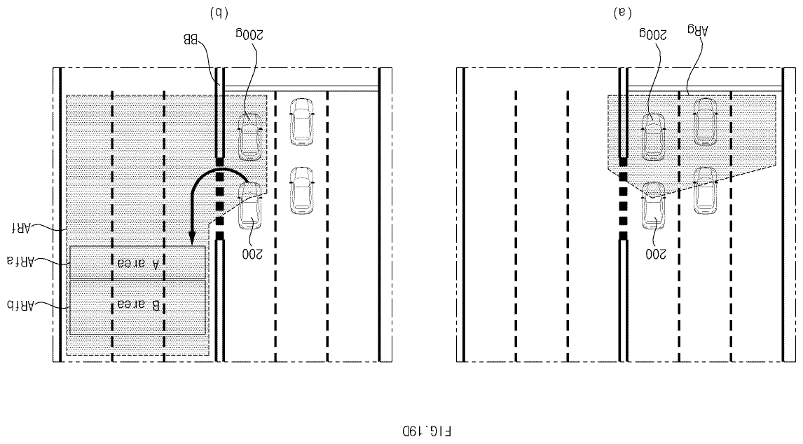

FIG. 19A is a diagram illustrating a message passing zone in the case in which an autonomous emergency steering (AES) control application is executed.

Referring to FIG. 19A, while the vehicle 200 travels in a second lane BLb among a first lane BLa, a second lane BLb, and a third lane BLc, a second vehicle 200b and a third vehicle 300c may be located ahead in the second lane BLb and the third lane BLc.

Meanwhile, the processor 670 may set a message passing zone based on a vehicle traveling direction in the case in which the AES control application is executed in the signal processing device 170.

In the case in which a driving direction of the vehicle 200 is a straight driving direction as illustrated in (a) of FIG. 19A, the processor 670 in the communication device 120 may set a front area AZa of the vehicle, including the three lanes BLa to BLc, as the message passing zone.

That is, in the case in which a driving direction of the vehicle 200 is a straight driving direction, the processor 670 in the communication device 120 may pass only vehicle messages from vehicles included in the front area AZa of the vehicle.

Meanwhile, in the case in which a driving direction of the vehicle 200 is about to change to the right lane as illustrated in (b) of FIG. 19A, the processor 670 in the communication device 120 may set, as the message passing zone, an area AZb including a right area and a front area of the two lanes BLb and BLc among the three lanes BLa to BLc.

That is, in the case in which a driving direction of the vehicle 200 is about to change to the right lane, the processor 670 in the communication device 120 may pass only vehicle messages from vehicles included in the area AZb including the right area and the front area of the two lanes BLb and BLc among the three lanes BLa to BLc. Accordingly, the vehicle messages may be efficiently filtered based on the AES control application executed in the signal processing device 170.

FIG. 19B is a diagram illustrating a message passing zone in the case in which an autonomous emergency braking (AEB) control application is executed.

Referring to FIG. 19B, while the vehicle 200 travels in a second lane BLb among a first lane BLa, a second lane BLb, and a third lane BLc, a second vehicle 200b may be located ahead in the second lane BLb.

In the case in which a driving direction of the vehicle 200 is a straight driving direction as illustrated in (a) of FIG. 19B, the processor 670 in the communication device 120 may set a front area AZc of the vehicle, including the three lanes BLa to BLc, as the message passing zone.

That is, in the case in which a driving direction of the vehicle 200 is a straight driving direction, the processor 670 in the communication device 120 may pass only vehicle messages from vehicles included in the front area AZc of the vehicle.

Meanwhile, the processor 670 may change a message passing zone to a rear area of the vehicle in the case in which the AEB control application is executed in the signal processing device 170.

That is, in the case in which the autonomous emergency braking control (AEC) application is executed in the signal processing device 170 as illustrated in (b) of FIG. 19B, the processor 670 may set, as the message passing zone, an area AZd including the front area of the second lane BLb and a rear area including the third vehicle 200d at the rear.

That is, the processor 670 in the communication device 120 may pass only vehicle messages from vehicles included in the area AZd including the front area of the second lane BLb and the rear area including the third vehicle 200d at the rear. Accordingly, the vehicle messages may be efficiently filtered based on the AEB control application executed in the signal processing device 170.

FIG. 19C is a diagram illustrating a message passing zone related to an opposite lane.

Referring to FIG. 19C, in the case in which the vehicle 200 travels in a first lane BLe adjacent to the centerline BL, the processor 670 in the communication device 120 may set, as a message passing zone, an area AZe including the first lane BLe adjacent to the centerline BL and two lanes beyond the centerline BL, as illustrated in (a) of FIG. 19C.

That is, the processor 670 in the communication device 120 may pass only vehicle messages from vehicles included in the area AZe including the first lane BLe adjacent to the centerline BL and the two lanes beyond the centerline BL. Accordingly, the vehicle messages may be efficiently filtered based on vehicle driving.

Meanwhile, in the case in which the vehicle 200 travels in the first lane BLe adjacent to the centerline BL on which a median strip is installed, the processor 670 in the communication device 120 may set, as a message passing zone, an area AZf including the two lanes beyond the centerline BL, while excluding the first lane BLe adjacent to the centerline BL, as illustrated in (b) of FIG. 19C.

That is, the median strip reduces the probability of crossing over the centerline, such that the processor 670 in the communication device 120 may control the message passing zone to become smaller than (a) of FIG. 19C.

As a result, the processor 670 in the communication device 120 may pass only vehicle messages from vehicles included in the area AZf including the two lanes beyond the centerline BL. Accordingly, the vehicle messages may be efficiently filtered based on vehicle driving.

FIG. 19D is a diagram illustrating a message passing zone before and after a U-turn.

Referring to FIG. 19D, in the case in which the vehicle 200 stops in a lane adjacent to the centerline BL, the processor 670 in the communication device 120 may set a front area ARg of the vehicle 200 as a message passing zone as illustrated in (a) of FIG. 19D.

As a result, in the case in which the vehicle 200 stops in the lane adjacent to the centerline BL, the processor 670 in the communication device 120 may pass only vehicle messages from vehicles included in the front area ARg of the vehicle 200. Accordingly, the vehicle messages may be efficiently filtered based on vehicle stopping.

Then, in the case in which the vehicle 200 makes a U-turn or is about to make a U-turn, the processor 670 in the communication device 120 may set, as a message passing area, an area ARf including a front area of a lane to which the vehicle 200 belongs and a plurality of lane areas beyond the centerline.

As a result, in the case in which the vehicle 200 makes a U-turn or is about to make a U-turn, and the vehicle stops in the lane adjacent to the centerline BL, the processor 670 in the communication device 120 may pass only vehicle messages from vehicles included in the front area of the lane to which the vehicle 200 belongs and the plurality of lane areas beyond the centerline. Accordingly, vehicle messages may be efficiently filtered based on U-turn of the vehicle.

Meanwhile, when the vehicle 200 makes a U-turn, the processor 670 in the communication device 120 may sequentially include an area ARfa and ARfb, corresponding to a front area after making a U-turn, as a message passing zone. Accordingly, the vehicle messages may be efficiently filtered based on U-turn of the vehicle.

As described above, a communication device and a vehicle control device including the same according to an embodiment of the present disclosure include: an RF communication device configured to receive vehicle messages from a plurality of adjacent external vehicles based on an RF signal; and a processor configured to perform filtering of the vehicle messages based on road type information, receiver sensitivity information of the RF signal, wheel direction information, and speed information. Accordingly, the vehicle messages received from the adjacent vehicles may be efficiently filtered. Particularly, the vehicle messages received from the adjacent vehicles may be efficiently filtered based on the road type information.

Meanwhile, the processor may be configured to set a message passing zone based on the road type information, receiver sensitivity information of the RF signal, wheel direction information, and speed information, and to perform filtering of the vehicle messages based on the message passing zone. Accordingly, the vehicle messages received from the adjacent vehicles may be efficiently filtered.

Meanwhile, the processor may be configured to pass vehicle messages from external vehicles included in the message passing zone, and to block vehicle messages from external vehicles not included in the message passing zone. Accordingly, the vehicle messages received from the adjacent vehicles may be efficiently filtered.

Meanwhile, the processor may be configured to set priority levels based on the road type information, receiver sensitivity information of the RF signal, wheel direction information, and speed information, and to perform filtering of the vehicle messages based on the priority levels. Accordingly, the vehicle messages received from the adjacent vehicles may be efficiently filtered.

Meanwhile, in response to the road type being a straight road or a curved road, the processor may be configured to set a priority level of the speed information to a highest level and a priority level of the wheel direction information to a lowest level; and in response to the road type being an intersection, the processor may be configured to set a priority level of the wheel direction information to a highest level and a priority level of the speed information to a lowest level. Accordingly, the vehicle messages received from the adjacent vehicles may be efficiently filtered.

Meanwhile, the processor may be configured to set a message passing zone based on the set priority levels, and to perform filtering of the vehicle messages based on the message passing zone. Accordingly, the vehicle messages received from the adjacent vehicles may be efficiently filtered.

Meanwhile, in response to the road type being a straight road or a curved road, the processor may be configured to increase the message passing zone as a level of the speed information increases. Accordingly, the vehicle messages received from the adjacent vehicles may be efficiently filtered.

Meanwhile, in response to the road type being an intersection, the processor may be configured to set a direction or location of the message passing zone based on the wheel direction information. Accordingly, the vehicle messages received from the adjacent vehicles may be efficiently filtered.

Meanwhile, the processor may be configured to set the priority levels based further on a turn signal, traffic congestion area information, and speed variation information. Accordingly, the vehicle messages received from the adjacent vehicles may be efficiently filtered.

Meanwhile, the processor may be configured to decrease the message passing zone as a congestion level based on the traffic congestion information increases or a speed variation of the speed variation information decreases. Accordingly, the vehicle messages received from the adjacent vehicles may be efficiently filtered.

Meanwhile, in response to a utilization of the processor being greater than or equal to a reference value, the processor may be configured to perform filtering of the vehicle messages. Accordingly, the vehicle messages received from the adjacent vehicles may be efficiently filtered.

Meanwhile, the processor may be configured to block a first number of vehicle messages in response to a utilization of the processor being a first level, and to block a second number of vehicle messages in response to a utilization of the processor being a second level greater than the first level, the second number being greater than the first number. Accordingly, the vehicle messages received from the adjacent vehicles may be efficiently filtered.

Meanwhile, the processor may be configured to decrease the message passing zone as the utilization of the processor increases. Accordingly, the vehicle messages received from the adjacent vehicles may be efficiently filtered.

Meanwhile, the RF communication device may be configured to transmit transmission interval information of the vehicle messages to the external vehicles based on the message passing zone. Accordingly, the vehicle messages received from the adjacent vehicles may be efficiently filtered.

Meanwhile, the RF communication device may be configured to control a transmission interval of the vehicle messages of the external vehicles to become longer as a size of the message passing zone decreases. Accordingly, the vehicle messages received from the adjacent vehicles may be efficiently filtered.

Meanwhile, the communication device may further include an interface configured to exchange data with a signal processing device, wherein the processor may be configured to set the message passing zone based on an application executed in the signal processing device. Accordingly, the vehicle messages may be efficiently filtered based on the application executed in the signal processing device.

Meanwhile, the processor may be configured to change the message passing zone based on an application executed in the signal processing device and a traveling direction of the vehicle. Accordingly, the vehicle messages may be efficiently filtered based on an autonomous emergency steering (AES) control application executed in the signal processing device.

Meanwhile, in response to an AES control application being executed in the signal processing device, the processor may be configured to change the message passing zone based on a traveling direction of the vehicle. Accordingly, the vehicle messages may be efficiently filtered based on the AES control application executed in the signal processing device.

Meanwhile, in response to an autonomous emergency braking (AEB) control application being executed in the signal processing device, the processor may be configured to change the message passing zone to a rear area of the vehicle. Accordingly, the vehicle messages may be efficiently filtered based on the AEB control application executed in the signal processing device.

A communication device and a vehicle control device including the same according to another embodiment of the present disclosure include: an RF communication device configured to receive vehicle messages from a plurality of adjacent external vehicles based on an RF signal; and a processor configured to perform filtering of the vehicle messages, wherein the processor is configured to perform filtering of the vehicle messages based on road type information and a utilization of the processor. Accordingly, the vehicle messages received from the adjacent vehicles may be efficiently filtered based on the road type information and the utilization of the processor.

It will be apparent that, although the preferred embodiments have been shown and described above, the present disclosure is not limited to the above described specific embodiments, and various modifications and variations can be made by those skilled in the art without departing from the gist of the appended claims. Thus, it is intended that the modifications and variations should not be understood independently of the technical spirit or prospect of the present disclosure.

What is claimed is:

1. A communication device in a vehicle comprising:
an RF communication device configured to receive vehicle messages from a plurality of adjacent external vehicles based on an RF signal; and
a processor configured to perform filtering of the vehicle messages based on road type information, receiver sensitivity information of the RF signal, wheel direction information, and speed information.

2. The communication device of claim 1, wherein the processor is configured to set a message passing zone based on the road type information, receiver sensitivity information of the RF signal, wheel direction information, and speed information, and to perform filtering of the vehicle messages based on the message passing zone.

3. The communication device of claim 2, wherein the processor is configured to pass vehicle messages from external vehicles included in the message passing zone, and to block vehicle messages from external vehicles not included in the message passing zone.

4. The communication device of claim 1, wherein the processor is configured to set priority levels based on the road type information, receiver sensitivity information of the RF signal, wheel direction information, and speed information, and to perform filtering of the vehicle messages based on the priority levels.

5. The communication device of claim 4, wherein:
in response to the road type being a straight road or a curved road, the processor is configured to set a priority level of the speed information to a highest level and a priority level of the wheel direction information to a lowest level; and
in response to the road type being an intersection, the processor is configured to set a priority level of the wheel direction information to a highest level and a priority level of the speed information to a lowest level.

6. The communication device of claim 4, wherein the processor is configured to set a message passing zone based on the set priority levels, and to perform filtering of the vehicle messages based on the message passing zone.

7. The communication device of claim 4, wherein in response to the road type being a straight road or a curved road, the processor is configured to increase the message passing zone as a level of the speed information increases.

8. The communication device of claim 4, wherein in response to the road type being an intersection, the processor is configured to set a direction or location of the message passing zone based on the wheel direction information.

9. The communication device of claim 4, wherein the processor is configured to set the priority levels based further on a turn signal, traffic congestion area information, and speed variation information.

10. The communication device of claim 9, wherein the processor is configured to decrease the message passing zone as a congestion level based on the traffic congestion information increases or a speed variation of the speed variation information decreases.

11. The communication device of claim 1, wherein in response to a utilization of the processor being greater than or equal to a reference value, the processor is configured to perform filtering of the vehicle messages.

12. The communication device of claim 11, wherein the processor is configured to block a first number of vehicle messages in response to a utilization of the processor being a first level, and to block a second number of vehicle messages in response to a utilization of the processor being a second level greater than the first level, the second number being greater than the first number.

13. The communication device of claim 2, wherein the processor is configured to decrease the message passing zone as the utilization of the processor increases.

14. The communication device of claim 2, wherein the RF communication device is configured to transmit transmission interval information of the vehicle messages to the external vehicles based on the message passing zone.

15. The communication device of claim 14, wherein the RF communication device is configured to control a transmission interval of the vehicle messages of the external vehicles to become longer as a size of the message passing zone decreases.

16. The communication device of claim 2, further comprising an interface configured to exchange data with a signal processing device,
wherein the processor is configured to set the message passing zone based on an application executed in the signal processing device.

17. The communication device of claim 16, wherein in response to an autonomous emergency steering (AES) control application being executed in the signal processing device, the processor is configured to change the message passing zone based on a traveling direction of the vehicle.

18. The communication device of claim 16, wherein in response to an autonomous emergency braking (AEB) control application being executed in the signal processing device, the processor is configured to change the message passing zone to a rear area of the vehicle.

19. A communication device in a vehicle comprising:
an RF communication device configured to receive vehicle messages from a plurality of adjacent external vehicles based on an RF signal; and
a processor configured to perform filtering of the vehicle messages,
wherein the processor is configured to perform filtering of the vehicle messages based on road type information and a utilization of the processor.

20. A vehicle control device comprising a communication device
wherein the communication device comprises:
an RF communication device configured to receive vehicle messages from a plurality of adjacent external vehicles based on an RF signal; and
a processor configured to perform filtering of the vehicle messages based on road type information, receiver sensitivity information of the RF signal, wheel direction information, and speed information.
